(19) United States
(12) Patent Application Publication
(10) Pub. No.: US 2022/0355891 A1
(43) Pub. Date: Nov. 10, 2022

(54) Vehicle Wheel Axle Assembly

(71) Applicant: Raphael Schlanger, Wilton, CT (US)

(72) Inventor: Raphael Schlanger, Wilton, CT (US)

(21) Appl. No.: 17/814,857

(22) Filed: Jul. 26, 2022

Related U.S. Application Data
(63) Continuation-in-part of application No. 16/517,552, filed on Jul. 20, 2019, now Pat. No. 11,407,470.
Application No. 16/517,552 is a continuation-in-part of application No. 16/377,167, filed on Apr. 6, 2019, now Pat. No. 11,001,333.
Application No. 16/377,167 is a continuation-in-part of application No. 15/681,410, filed on Aug. 20, 2017, now Pat. No. 10,676,149.
Application No. 15/681,410 is a continuation-in-part of application No. 14/974,228, filed on Dec. 18, 2015, now abandoned.
Application No. 14/974,228 is a continuation-in-part of application No. 14/974,451, filed on Dec. 18, 2015, now Pat. No. 9,758,209.
Application No. 14/974,451 is a continuation-in-part of application No. 14/958,263, filed on Dec. 3, 2015, now Pat. No. 10,112,439.
Application No. 14/958,263 is a continuation-in-part of application No. 14/952,645, filed on Nov. 25, 2015, now Pat. No. 9,815,329.
Application No. 14/952,645 is a continuation-in-part of application No. 14/602,543, filed on Jan. 22, 2015, now Pat. No. 9,561,833.
Application No. 14/602,543 is a continuation-in-part of application No. 13/914,490, filed on Jun. 10, 2013, now Pat. No. 9,446,626.
Application No. 13/914,490 is a continuation-in-part of application No. 12/655,433, filed on Dec. 30, 2009, now Pat. No. 8,485,335.
(60) Provisional application No. 62/700,925, filed on Jul. 20, 2018.
(60) Provisional application No. 62/653,575, filed on Apr. 6, 2018.
(60) Provisional application No. 62/381,155, filed on Aug. 30, 2016.
(60) Provisional application No. 62/124,391, filed on Dec. 18, 2014.
(60) Provisional application No. 61/965,201, filed on Jan. 27, 2014.
(60) Provisional application No. 61/204,130, filed on Jan. 2, 2009.

(51) Int. Cl. B62K 25/02; B60B 27/02

(52) U.S. Cl. CPC B62K 25/02; B60B 27/023; B62K 2206/00

(57) ABSTRACT

An axle assembly, including: an axle sleeve having first end face; a second end face axially spaced from said first end face and an axially extending opening therethrough;a control shaft assembly including: a control shaft and an engagement element having an engagement surface. The engagement element is axially retained to the control shaft. The control shaft assembly extends within the opening to be axially overlapping the axle sleeve. The engagement element has a restraining engagement with the axle sleeve at an engagement interface between the engagement surface and opening; the restraining engagement providing a restraining resistance to restrain axial displacement between the control shaft and axle sleeve. The engagement element fully circumscribes the control shaft about the axial axis and is radially self-supporting.

### CROSS-REFERENCE TO RELATED APPLICATIONS

This application is a Continuation-In-Part of U.S. patent application Ser. No. 16/517,552 filed Jul. 20, 2019, which is currently pending.

U.S. patent application Ser. No. 16/517,552 claims priority of U.S. Provisional Patent application 62/700,925, filed Jul. 20, 2018.

U.S. patent application Ser. No. 16/517,552 is also a Continuation-In-Part of U.S. patent application Ser. No. 16/377,167 filed Apr. 6, 2019, which was issued as U.S. Pat. No. 11,001,333 on May 11, 2021.

U.S. patent application Ser. No. 16/377,167 claims priority of U.S. Provisional Patent Application 62/653,575, filed Apr. 6, 2018, which has expired.

U.S. patent application Ser. No. 16/377,167 is a Continuation-In-Part of U.S. patent application Ser. No. 15/681,410, filed Aug. 20, 2017, which was issued as U.S. Pat. No. 10,676,149 on Jun. 9, 2020.

U.S. patent application Ser. No. 15/681,410 claims priority of U.S. Provisional Patent application 62/381,155, filed Aug. 30, 2016 and entitled “VEHICLE WHEEL AXLE ASSEMBLY”, which has expired.

U.S. patent application Ser. No. 15/681,410 is also a Continuation-In-Part of U.S. patent application Ser. No. 14/974,228, filed Dec. 18, 2015, which is abandoned.

U.S. patent application Ser. No. 15/681,410 is also a Continuation-In-Part of U.S. patent application Ser. No. 14/974,451, filed Dec. 18, 2015, which was issued as U.S. Pat. No. 9,758,209 on Sep. 12, 2017.

U.S. patent application Ser. No. 14/974,451 claimed priority of U.S. Provisional Patent Application 62/124,391, filed Dec. 18, 2014, which has since expired.

U.S. Patent application Ser. No. 14/974,451 is also a Continuation-In-Part of U.S. patent application Ser. No. 14/958,263 filed Dec. 3, 2015, which was issued as U.S. Pat. No. 10,112,439 on Oct. 30, 2018.

U.S. patent application Ser. No. 14/958,263 is a Continuation-In-Part of U.S. patent application Ser. No. 14/952,645 filed Nov. 25, 2015, which was issued as U.S. Pat. No. 9,815,329 on Nov. 14, 2017.

U.S. Patent application Ser. No. 14/952,645 is a Continuation-In-Part of U.S. patent application Ser. No. 14/602,543 filed Jan. 22, 2015, which is which was issued as U.S. Pat. No. 9,561,833 on Feb. 2, 2017.

U.S. patent application Ser. No. 14/602,543 claimed priority of U.S. Provisional Patent Application 61/965,201 filed Jan. 27, 2014, which has since expired.

U.S. patent application Ser. No. 14/602,543 is also a Continuation-In-Part of U.S. patent application Ser. No. 13/914,490 filed Jun. 10, 2013, which was issued as U.S. Pat. No. 9,446,626 on Sep. 20, 2016.

U.S. patent application Ser. No. 13/914,490 is a Continuation-In-Part of U.S. patent application Ser. No. 12/655,433 filed Dec. 30, 2009, which was issued as U.S. Pat. No. 8,485,335 on Jul. 16, 2013.

U.S. patent application Ser. No. 12/655,433 claimed priority of U.S. Provisional Patent Application 61/204,130 filed Jan. 2, 2009, which has since expired.

### BACKGROUND OF THE INVENTION

The present invention relates to a vehicle wheel axle assembly. The axle assembly includes an axle sleeve and a control shaft that is axially guided and axially displaceable within the axle sleeve. The axle assembly includes a retaining means that may: control the axial position of the control shaft relative to the axle sleeve; and/or retain the control shaft with the axle sleeve; and/or provide tactile feedback to the operator that may be used to signal the preferred axial position of the control shaft relative to the axle sleeve. Preferably, the control shaft is and coaxial and rotatable relative to the axle sleeve.

### BACKGROUND—DISCUSSION OF PRIOR ART

U.S. Pat. No. 6,089,675 describes a vehicle (i.e. bicycle) wheel hub that includes a control shaft that is internally coaxial with an axle sleeve. As illustrated in FIGS. 4a-f of this patent, the control shaft is axially displaceable relative to the axle sleeve, however the control shaft has a blocking engagement with the axle sleeve that prevents the control shaft from being withdrawn and removed from the axle sleeve without completely disassembling the hub assembly.

It is often desirable to remove the control shaft from the axle sleeve in order to service the hub and/or to replace the control shaft with a different type. For example, different bicycles may include dropouts that have different threading or that may be of a different type. In such a case, when swapping wheels and bicycle frames, it may be desirable to also swap out the control shaft to insure compatibility with the dropouts of a given frame. Since the control shaft of U.S. Pat. No. 6,089,675 cannot be removed from the sleeve, the entire axle and/or sleeve assembly must be disassembled in order to replace the control shaft. This is a great inconvenience to the operator since this is a time-consuming procedure and also requires special tools and skills that many operators may not have.

While there are conventional through-axle axle assemblies available, these assemblies lack any means to retain the control shaft with the axle sleeve and the control shaft may easily become inadvertently separated from the axle sleeve. This is an inconvenience for the operator. Further, the control shaft may then become lost or misplaced or damaged. Further, these conventional through-axle assemblies do not require, nor do they provide, any means to control the axial position of the control shaft relative to the axle sleeve.

In certain axle assemblies, such as FIGS. 4a-f of U.S. Pat. No. 6,089,675, it is desirable to provide some means to control the axial position of the control shaft, particularly when positioning the control shaft in the precise axial location such that it may be radially assembled and disassembled to the dropouts. Since conventional through-axle assemblies lack this ability for axial position control, the operator must manually position the control shaft in the proper axial position by trial-and-error in order to install and remove the wheel to/from the dropouts of the frame. For the operator, this adds significant frustration, complexity, and skill requirement to this installation and removal process.

Accordingly, it is an objective of the present invention to overcome the forgoing disadvantages and provide an improved vehicle wheel hub assembly, particularly as applied to a bicycle wheel.

### SUMMARY OF THE INVENTION—OBJECTS AND ADVANTAGES

The present invention utilizes an engagement interface between the control shaft assembly and the axle sleeve. This engagement interface restricts the control shaft from being inadvertently separated from the axle sleeve and the hub to which the sleeve is connected. This helps to prevent the control shaft from being lost, misplaced, or damaged.

Further, this interface can be utilized to provide a stop to restrain and/or limit the axial travel of the control shaft at a predetermined axial position relative to the axle sleeve. This may serve to control the axial position of the control shaft in the extending direction and/or the retracting direction such that the control shaft is properly axially aligned to provide the requisite clearance to install and remove the wheel to/from the dropouts of the frame.

Still further, this interface may serve to provide tactile feedback to the operator to indicate that the control shaft is in the predetermined axial position relative to the axle sleeve. This provides a helpful convenience for the operator and eliminates the trial-and-error associated with axially positioning the control shaft of conventional through-axle arrangements. In the case where the pre-determined axial position corresponds to the retracted position, this minimizes the operator's frustration, complexity, and skill requirement associated with the wheel installation and removal process.

Yet further, this engagement interface may be yieldable interface where the operator needs merely to overcome this engagement interface in order to withdraw and remove the control shaft from the axle sleeve, without any additional action required. This is a highly intuitive process that requires very little instruction to the operator.

Since the control shaft may be withdrawn and removed from the axle sleeve as described, the operator may swap out different control shafts and may easily service and clean the control shaft without completely disassembling the hub assembly.

Further features of the present invention will become apparent from considering the drawings and ensuing description.

### BRIEF DESCRIPTION OF THE DRAWINGS

The present invention will be more readily understandable from a consideration of the accompanying exemplificative drawings, wherein:

FIG. la is a perspective view schematically illustrating the general configuration of a vehicle wheel as applied to a bicycle wheel.

FIG. 2a is a perspective exploded view of a first embodiment of the present invention, showing a control shaft and a two-piece engagement element comprising two spring clips;

FIG. 2b a perspective view of a first embodiment of the present invention, showing the spring clips assembled to the control shaft with circumferentially overlapping spring fingers;

FIG. 2c is an exploded perspective view of the embodiment of FIG. 2a, detailing the individual spring clips of the two-piece engagement element;

FIG. 2d is a perspective view of the embodiment of FIG. 2a, detailing the spring clips assembled to the control shaft with circumferentially overlapping spring fingers;

FIG. 2e is an exploded cross section view of the embodiment of FIG. 2a, taken along 72-72 detailing the individual spring clips of the two-piece engagement element;

FIG. 2f is a cross section view of the embodiment of FIG. 2a, taken along 72-72 detailing the individual spring clips as assembled to each other with circumferentially overlapping spring fingers;

FIG. 2g is a cross section detail view of the embodiment of FIG. 2a, taken along 35-35 and showing the control shaft assembly of FIG. 2b.

FIG. 2h is a cross section exploded view of the embodiment of FIG. 2a, taken along 35-35 and showing the hub assembly having an axle sleeve and the control shaft assembly of FIG. 2b.

FIG. 2i is a cross section detail view of the embodiment of FIG. 2a, taken along 35-35 and showing the control shaft assembly of FIG. 2b as assembled to the axle sleeve, with the control shaft in the extended position.

FIG. 2j is a cross section detail view of the embodiment of FIG. 2a, taken along 35-35 and showing the control shaft assembly of FIG. 2b as assembled to the axle sleeve, with the control shaft in the retracted position.

FIG. 2k is a cross section detail view of an alternate to the embodiment of FIG. 2a, taken along 35-35, including an alternate control shaft having a narrow relief to provide close axial positioning of the engagement element with the control shaft.

FIG. 2L is a cross section detail view of the embodiment of FIG. 2k, taken along 69-69 illustrating radial clearance between the engagement element and the control shaft.

FIG. 3a is a perspective view of a second embodiment of the present invention, showing flex sleeve as pre-assembled to the control shaft, with the flex sleeve in the open position to include a gap between ends;

FIG. 3b is a perspective view of the embodiment of FIG. 3a, showing flex sleeve as next flexed to the closed position with the ends abutting each other;

FIG. 3c is a perspective view of the embodiment of FIG. 3a, showing flex sleeve in the open position to include a gap between ends;

FIG. 3d is a cross section view of the embodiment of FIG. 3a, taken along 123-123 showing flex sleeve in the open position to include a gap between ends;

FIG. 3e is a perspective view of the embodiment of FIG. 3a, showing flex sleeve in the closed position;

FIG. 3f is a cross section view of the embodiment of FIG. 3a, taken along 123-123 showing flex sleeve in the closed position;

FIG. 3g is a cross section detail view of the embodiment of FIG. 2a, taken along 127-127 and showing the control shaft assembly of FIG. 3b as assembled to the axle sleeve, with the control shaft in the retracted position.

FIG. 4a is a perspective exploded view of a third embodiment of the present invention, showing a mating pair of split sleeves prior to their assembly with a mating control shaft;

FIG. 4b is a perspective view of the embodiment of FIG. 4a, showing split sleeves as next assembled to each other;

FIG. 4c is a perspective view of the embodiment of FIG. 4a, showing a mating pair of split sleeves aligned for assembly with a mating control shaft;

FIG. 4d is a perspective view of the embodiment of FIG. 4a, showing a mating pair of split sleeves assembled to each other to circumferentially surround a mating control shaft;

FIG. 4e is a cross section view of the embodiment of FIG. 4a, taken along 163-163 showing flex sleeve in the open position corresponding to the view of FIG. 4a;

FIG. 4f is a perspective exploded view of a fourth embodiment of the present invention, showing a mating pair of split sleeves prior to their assembly with a mating control shaft, including a pair of o-rings;

FIG. 4g is a perspective view of the embodiment of FIG. 4f, showing split sleeves as next assembled to each other, with o-rings positioned in mating grooves;

FIG. 4h is a cross section view of the embodiment of FIG. 4f, taken along 193-193 corresponding to the configuration of FIG. 4g;

FIG. 4i is a perspective view of the embodiment of FIG. 4f, showing the assembly of FIG. 4g as further assembled a mating control shaft;

FIG. 5a is a perspective view of a fifth embodiment of the present invention, showing the engagement element as a helical coil;

FIG. 5b is an orthogonal view of the embodiment of FIG. 6a, showing the helical coil in end view as viewed along the axial axis;

FIG. 5c is an orthogonal view of the embodiment of FIG. 6a, showing the helical coil in side view taken perpendicular to the view of FIG. 5b;

FIG. 5d is a perspective view of the embodiment of FIG. 5a, showing the helical coil of FIG. 5a as further assembled a mating control shaft;

FIG. 6a is a perspective view of a sixth embodiment of the present invention, showing the engagement element as a spiral coil;

FIG. 6b is an orthogonal view of the embodiment of FIG. 6a, showing the spiral coil in end view as viewed along the axial axis;

FIG. 6c is a perspective view of the embodiment of FIG. 6a, showing the spiral coil of FIG. 6a as further assembled a mating control shaft;

FIG. 7a is a perspective view of a seventh embodiment of the present invention, showing a continuous circumferential engagement element as a cylindrical tube;

FIG. 7b is a perspective view of the embodiment of FIG. 7a, showing the engagement element of FIG. 7a as further assembled a mating control shaft;

FIG. 7c is cross section detail, taken along 238-238 view of the embodiment of FIG. 6a, showing the spiral coil of FIG. 6a as further assembled a mating control shaft;

### DETAILED DESCRIPTION OF THE INVENTION

FIG. la describes the basic configuration of an exemplary prior art vehicle wheel, in particular, a bicycle wheel 1, as well as a description of the direction conventions used throughout this disclosure. For clarity, the bicycle frame and the quick release skewer assembly are not shown in this figure. The hub shell 14 is rotatable about the axle 9 and includes at least two axially spaced hub flanges 16a and 16b, each of which include a means for connecting with a multiplicity of spokes 2 connected thereto. Axle 9 includes ends Ila and llb that define the spacing of its mounting with the frame (not shown). The axial axis 28 is the axial centerline of rotation of the bicycle wheel assembly 1. The hub flanges 16a and 16b may be contiguous with the hub shell 14 or may be separately formed and assembled to the hub body 12 portion of the hub shell 14. Each spoke 2 is affixed to its respective hub flange 16a or 16b at its first end 4 and extend to attach the rim 8 at its second ends 6. The tire 10 is fitted to the outer periphery of the rim 8. The wheel of FIG. 1 is generic and may be of tension-spoke or compression-spoke design.

The axial direction 92 is any direction parallel with the axial axis 28. The radial direction 93 is a direction generally perpendicular to the axial direction 92 and extending generally from the axial axis 28 radially outwardly toward the rim 8. The tangential direction 94 is a direction generally tangent to the rim at a given radius. The circumferential direction 95 is a cylindrical vector that wraps around the axial axis 28 at a given radius. A radial plane 96 is a plane perpendicular to the axial axis 28 that extends in a generally radial direction at a given axial intercept. An axial plane 97 is a plane that is generally parallel to the axial axis. An orientation that is radially inboard (or inward) is nearer to the axial axis 28 of rotation and a radially outboard (or outward) is further from the axial axis. An axially inboard (or inward) orientation is an orientation that is axially proximal to the axial midpoint between the two ends 11a and 11b. Conversely, an axially outboard (or outward) orientation is an orientation that is axially distal to the axial midpoint between the two ends 11a and 11b. A radially inboard orientation is an orientation that is radially proximal to the axial axis 28 and a radially outboard orientation is an orientation that is radially distal to the axial axis 28. An axially inwardly facing surface is a surface that faces toward the axial midpoint between the two ends Ila and 11b. Conversely, an axially outwardly facing surface is a surface that faces away from the axial midpoint between the two ends 11a and 11b. While it is most common for the hub shell 14 to rotate about a fixed axle 9, there are some cases where it is desirable to permit the axle 9 to be fixed with the wheel 1 such as the case where the wheel 1 is driven by the axle 9.

For the purposes of using conventional terminology, the term “hub flange” is used herein to describe a region of the hub shell 14 to which the spokes 2 are joined. While the surface of the hub flange may be raised and flange-like in comparison to other surfaces of the hub shell 14, this is not a requirement for the present invention and the hub flange 16 may alternatively be flush or recessed relative to other hub shell surfaces.

As is well known in the art, a wheel 1 may be of tension-spoke construction, where the central hub hangs in tension by the spokes from the rim portion directly above, or it may be of compression-spoke construction, where the hub is supported by compressing the spoke directly beneath it. Since the present invention may be directed toward bicycle wheels and since the tension-spoke wheel is generally a more efficient structure than compression-spoke wheel, most of the discussion herein is focused with an eye toward tension-spoke wheel construction. However, it is anticipated that most, if not all, of the embodiments of the present invention may be adapted or otherwise applied to compression-spoke wheel construction as well. For a tension-spoke wheel, it is preferable that the wheel includes at least two hub flanges that are axially spaced on either side of the rim or, more specifically, the spoke attachment points at the rim. Thus the spokes fixed to opposite hub flanges will converge as they extend to the rim. Additionally, a tension-spoke wheel will usually be pre-tensioned during assembly to create a pre-tensioned structure of balanced spoke tension that allows the axle supporting loads to be distributed among several, if not all, of the spokes of the wheel. It is this ability to share the stresses among its spokes that helps to make the tension-spoke wheel the highly efficient structure that it is. For a compression-spoke wheel, it is often preferable to employ at least two axially spaced hub flanges, however, in the case where the spokes have sufficient bending stiffness to support the requisite lateral or side-to-side loads, only a single hub flange may be employed.

The spoke 2 is a generally long slender tensile element with a longitudinal axis 62 along its length and generally parallel to its sidewalls. The spoke 2 also has a tensile axis 61 of applied tensile load 58 that extends along the span portion of the spoke 2 between its anchor points at the rim 8 and hub flange 16. The tensile axis 61 is generally collinear to the longitudinal axis 62, except where the spoke 2 is bent to deviate from the tensile axis 61. For the purposes of definition, as relating to spokes 2 and connections thereto, the term “longitudinal” herein refers to alignment along the longitudinal axis 62. A longitudinally inboard (or inward) orientation refers to an orientation proximal the midpoint of the span portion. Conversely, a longitudinally outboard (or outward) orientation refers to an orientation distal the midpoint of the span portion. The term “lateral” herein refers to an orientation in a direction generally perpendicular to the longitudinal axis 62. A laterally inboard (or inward) orientation refers to an orientation proximal the longitudinal axis. Conversely, a laterally outboard (or outward) orientation refers to an orientation distal the longitudinal axis 62.

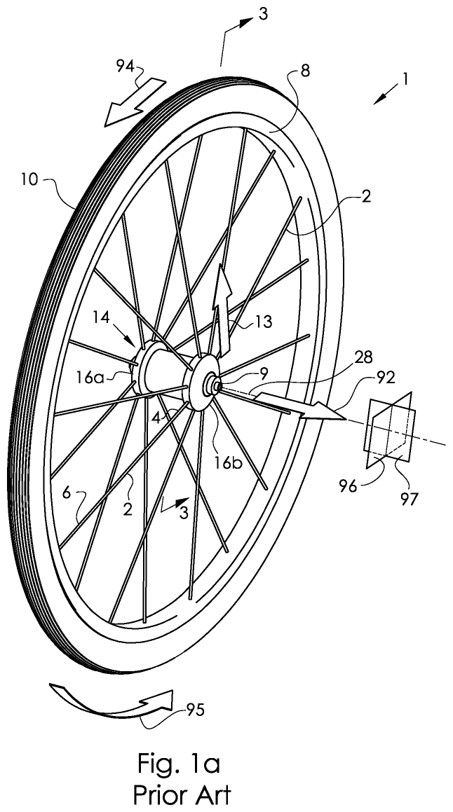

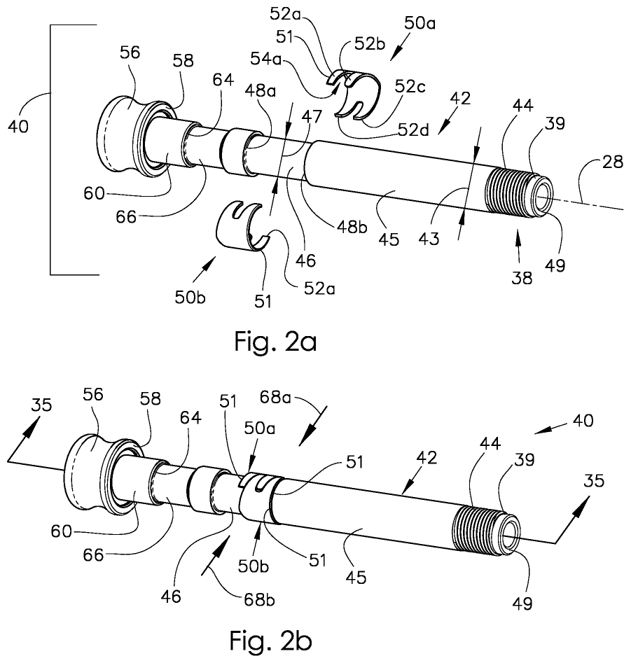

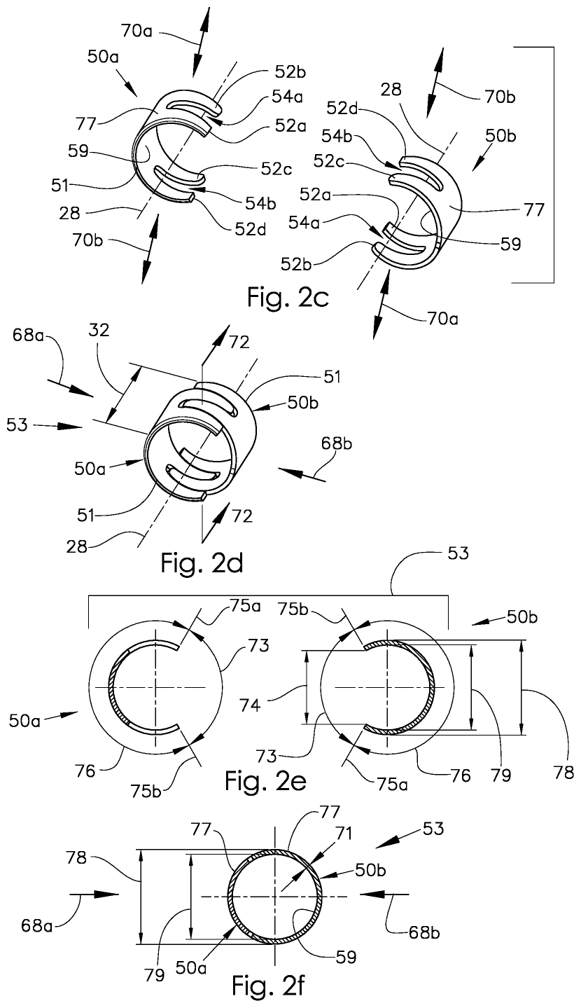

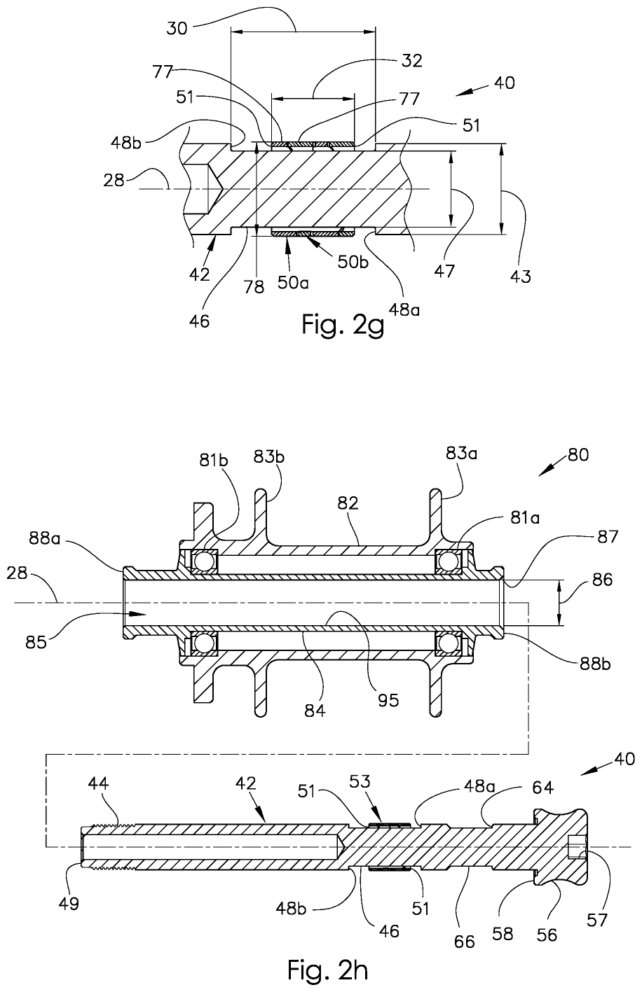

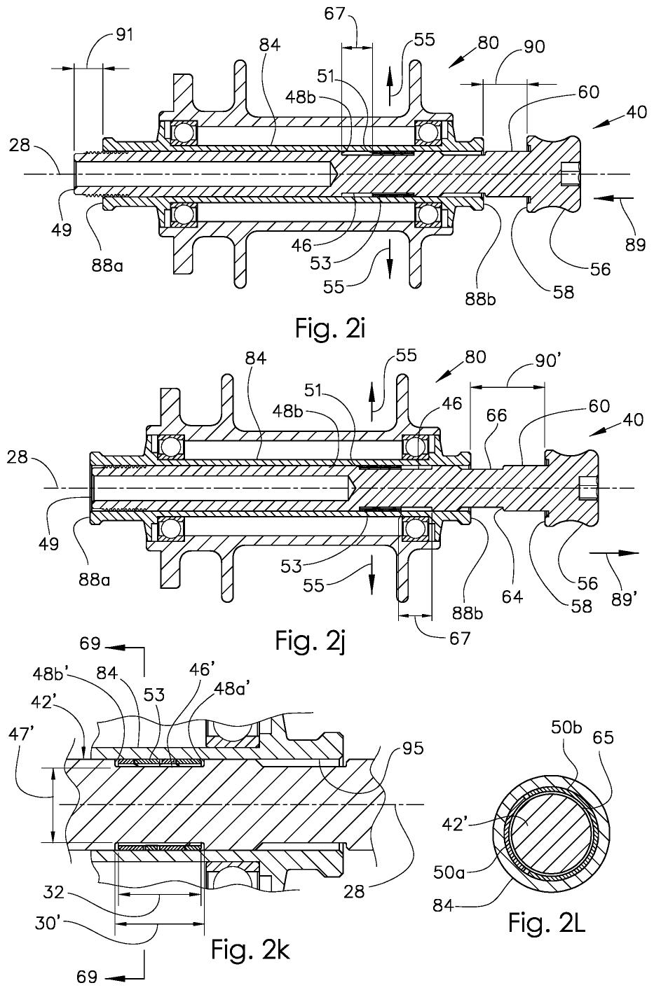

FIGS. 2a-j describe a first embodiment of the present invention where the control shaft assembly 40 includes a control shaft 42 and two spring clips 50a and 50b. Spring clips 50a and 50b are circumferentially overlapping with each other to fully circumscribe and surround the axial axis 28 of the control shaft 42.

Reference is made to U.S. Pat. No. 10,676,149, which is incorporated herein by reference, where FIGS. 2a-L provide an exemplary description of how the control shaft and hub assembly and may be assembled and disassembled to/from the dropouts. While certain geometric and functional details of the present invention may be different from U.S. Pat. No. 10,676,149, the overall schematic interaction between the control shaft and the dropouts described during the assembly/disassembly procedure provide an exemplary background of how the present control shaft may interface with similar dropouts that are otherwise not detailed herein.

The hub assembly 80 includes sleeve assembly 84, two bearing assemblies 81a and 81b, and hub shell 82. In this case, the sleeve assembly 84 is generally stationary and intended to be rotationally fixed to the frame of the bicycle (not shown), while the hub shell 82 is rotatable about axial axis 28 and about the sleeve assembly 84 by means of bearing assemblies 81a and 81b. Bearing assemblies 81a and 81b are shown here as conventional “cartridge” type bearing assemblies, including rolling elements, an inner race, and an outer race. The hub shell 82 includes two hub flanges 83a and 83b that may be adapted with spoke holes (not shown herein for clarity) to connect with the first ends of spokes (not shown) in the conventional manner. The sleeve assembly 84, which may be also termed the “axle sleeve”, includes an axial bore or opening 85 therethrough extending between ends 88a and 88b. There is a lead-in chamfer 87 between opening 85 and end 88b. In the example shown in FIGS. 2g-j, opening 85 is a smooth cylindrical bore of diameter 86 that is preferably sized to have a close sliding clearance fit with the diameter 43 of the shank portion 45 of the control shaft 42. The hub assembly 80 shown here is shown in schematic form and corresponds to a conventional front hub assembly that s well known in industry. Sleeve assembly 84 is shown as a simplified singular element for schematic description purposes. It is anticipated that the sleeve assembly 84 will preferably be comprised of multiple individual components that are assembled together, as is well known in industry.

Control shaft 42 includes a shank portion 45 and an enlarged head portion 56, with a grip face 58 serving as a transition surface between the collar portion 60 and head portion 56. The shank portion 45 is the portion of the control shaft 42 that extends axially from the grip face 58 to the end 49. Engagement end 38 of the shank portion 45 includes external threads 44, end 49 and pilot portion 39. Shank portion 45 also includes a cylindrical collar portion 60 and a necked portion 66 that is concentric and of smaller diameter than collar portion 60 such that there is a step or transition surface 64 therebetween. The necked portion 66 may be considered as a radially relieved surface relative to the collar portion 60 and the collar portion 60 may be considered as a radially enlarged surface relative to the necked portion 66. The head portion 56 extends axially outwardly from the grip face 58 and includes hex socket 57 for engagement with a hex key (not shown) to manipulate the control shaft in the conventional manner. Shank portion 45 also includes a cylindrical relief 46 having an axial width 30 and a diameter 47 that is radially relieved from diameter 43. Relief 46 extends axially between shoulders 48a and 48b.

Spring clip 50a is an elastic element that wraps circumferentially about axial axis 28 with wrap angle 76 and includes axially spaced spring fingers 52a and 52b at one circumferential end 75a, with gap 54a therebetween, and axially spaced spring fingers 52c and 52d at the opposite circumferential end 75b, with gap 54b therebetween. The tips of spring fingers 52a and 52b define circumferential end 75a and the tips of spring fingers 52c and 52d define the circumferentially opposite circumferential end 75b. Spring clip 50a has an end 51 at one axial terminus, an exterior surface 77 and an interior surface 59. There is a circumferential gap angle 73 between the tips of spring fingers 52a and 52b and the tips of spring fingers 52c and 52d as shown in FIG. 2e. The circumferential gap angle 73 plus the circumferential wrap angle 76 equals a 360 degrees. The circumferential gap 73 provides gap 74 that is preferably somewhat narrower than the diameter 47 of relief 46. In its unstressed and relaxed state, spring clip 50a has a relaxed outside diameter 78 and relaxed inside diameter 79.

Spring clip 50a is designed so that spring fingers 52ab may elastically flex in direction 70a and spring fingers 52cd may elastically flex in direction 70b. Spring clip 50a may be made from a variety of materials, and preferably made of spring-tempered steel. Spring clip 50b is identical to spring clip 50a.

FIG. 2a shows spring clips 50a and 50b in position to be assembled to the relief 46 of control shaft 42. The spring fingers 52a-d of spring clip 50a are opposed and facing spring fingers 52a-d of spring clip 50b. FIGS. 2b and 2g shows spring clips 50a and 50b assembled to control shaft 42 in radial directions 68a and 68b respectively such that the tips of spring fingers 52a-d are cammed to spread gap 74 against the surface of relief 46 to elastically snap over diameter 47 in a manner similar to the well-known arrangement where a snapring (such as an “e-ring”) may be radially assembled to a shaft. As is shown in FIGS. 2b and 2d, spring clips 50a and 50b are axially staggered such that spring finger 52a is circumferentially nested in gap 54a and spring finger 52d is circumferentially nested in gap 65b. These nested engagements serve to axially interlock spring clips 50a and 50b, axially engaging them to each other to limit axial displacement therebetween. Spring fingers 52a-d of spring clip 50a are shown in FIG. 2d to be axially offset and circumferentially overlapping 52a-d of spring clip 50b.

As particularly shown in FIG. 2f, the wrap angle 76 of spring clip 50a circumferentially overlaps the circumferential gap 74 of spring clip 50b and the wrap angle 76 of spring clip 50b circumferentially overlaps the circumferential gap 74 of spring clip 50a. The result is that this combined assembly 53 of spring clips 50a and 50b that circumferentially overlap each other with a combined circumferential wrap angle to fully circumscribe (i.e. surround) the relief 46 and circumferentially surround the axial axis 28. The zig-zag interface of nested spring fingers 52a-d shown in FIG. 2d may be considered a seam, split, or interruption of this 360 degrees as viewed along the axial axis, which is termed herein as a “circumferential discontinuity”. At the same time, the zig-zagging axial stagger of the spring fingers 52a-d nested within mating gaps 54a-b shown in FIG. 2d provide the circumferential overlap of spring clips 50a and 50b where the circumferential wrap of wrap angle 76 of spring clip 50a circumferentially overlaps the circumferential gap 74 of spring clip 50b and vice versa. As such, the combined assembly 53 fully circumscribes the relief 46 and circumferentially surrounds the axial axis 28 by greater than 360 degrees as viewed along the axial axis 28.

The combined assembly 53 has an axial width 32 between end 51 of spring clip 50a and end 51 of spring clip 50b. The outside diameter 78 of the combined assembly 53 is larger than the diameter 43 of shank portion 45 and also slightly larger than the diameter 86 of opening 85. The inside diameter 79 of the combined assembly 53 is smaller than the diameter 43 of shank portion 45 and larger than the diameter 47 of relief 46. Thus, the combined assembly 53 is axially retained between shoulders 48a and 48b of the control shaft 42, with radial clearance between inside diameter 79 and relief 46. FIG. 2b shows the control shaft assembly 40 to include the control shaft 42 plus the combined assembly 53. Due to the snap fit overlie between gaps 74 and diameter 47, both spring clips 50a and 50b are also radially retained to the control shaft 42.

FIG. 2h shows the control shaft assembly 40 in preparation for assembly with the hub assembly 80. FIG. 2i shows the control shaft assembly 40 as inserted in direction 89 within opening 85. Since diameter 86 is smaller than outside diameter 78 of spring clips 50a and 50b, there is a radial interference between the diameters 86 and 78, requiring a press or force or interference fit between the spring clips 50a and 50b and the opening 85 upon the assembly shown in FIGS. 2i-j. Thus, as the control shaft assembly 40 is inserted and displaced within opening 85, there is first the free insertion of the shank portion 45 in direction 89 until the end 51 of spring clip 50a contacts the chamfer 87. Next, the control shaft assembly 40 must be pressed in direction 89 so that shoulder 48a axially abuts and drives end 51 of spring clip 50b such that the chamfer 87 serves to wedge against the combined assembly 53 until the spring clips 50a and 50b yield elastically to deflect, deform, and flex radially inwardly as the combined assembly 53. The axial interlock of spring fingers 52a-d also cause the spring clip 50b to be displaced along with spring clip 50a so that combined assembly 53 is axially displaced as a unit. The control shaft assembly 40 is then further forced and pushed in direction 89 to push and drag the combined assembly 53 within the opening 85 to the position shown in FIG. 2i.

When spring clips 50a and 50b have both been elastically deflected and deformed such that their outside diameter 78 is reduced to conform to the interior diameter 86 dimension of opening 85, an interference fit between the combined assembly 53 and opening 85 is created and the combined assembly 53 can be further pressed in direction 89 to pass axially within opening 85 as shown in FIG. 2i. This elastic deflection imparts an elastic preload on the two spring clips 50a and 50b, which creates a radially outward spring-back energy and restoring force in direction 55. This restoring force serves to radially outwardly press exterior surface 77 against opening 85 at the interface where these two surfaces contact. The result is a frictional engagement interface between exterior surface 77 and the interior surface 95 of opening 85. This engagement interface provides a resistance and restraint to displacement of the combined assembly 53 in both axial and circumferential directions relative to axle sleeve 84. Combined assembly 53 may be considered an engagement element that is axially retained to the control shaft 42 and is engaged to the axle sleeve 84 at an engagement interface to axially retain the control shaft 42 to the axle sleeve 84.

Spring clips 50a and 50b are considered to be generally radially rigid elements where the radial thickness 71 between the interior surface 59 and exterior surface 77 does not appreciably change due to the aforementioned elastic deflection. Further, spring clips 50a and 50b have sufficient stiffness to be considered as “radially self-supporting” such that the aforementioned radially inwardly elastic deflection of spring clips 50a and 50b occurs within the spring clips 50a and 50b themselves and does not rely on the radial support of an external element, such as where interior surface 59 would otherwise brace or press radially inwardly against the relief 46 of the control shaft 42. The stiffness is sufficient to maintain the aforementioned engagement interface. Preferably, spring clips 50a and 50b do not radially brace or press against the relief 46 at all and instead have radial clearance between the interior surfaces 59 and the relief 46. This provides the potential benefit of allowing the control shaft 42 to circumferentially rotate freely within the combined assembly 53.

The grip face 58 is now axially spaced from end 88b by distance 90 and the end 49 is axially protruding from end 88a by distance 91. This is considered to be an “extended position” of the control shaft 42 with respect to the axle sleeve 84, with direction 89 considered to be an “extending direction”. Due to the restrained deflection of spring clips 50a and 50b within and against opening 85, the exterior surface 77 of spring clips 50a and 50b press radially outwardly against the interior surface 95 of opening 85, creating friction at a frictional gripping engagement interface therebetween. Thus, the combined assembly 53 is retained with the axle sleeve 84 in both the axial and circumferential directions. Since the combined assembly 53 is axially retained between shoulders 48a and 48b, the control shaft 42 is now also retained to the axle sleeve 84. However, because there preferably remains a radial clearance between the interior surface 59 and the relief 46, the control shaft 42 is free to circumferentially rotate within the combined assembly 53 and the axle sleeve 84.

Since the axial width 32 of the combined assembly 53 is smaller than the axial width 30 of the relief 46, there is an axial gap 67 or clearance therebetween. Thus, after the control shaft assembly 40 is inserted within the opening 85 as shown in FIG. 2i, the control shaft may next be freely axially displaced in direction 89′ by an axial distance 67, which corresponds to distance 91, until the end 51 of spring clip 50a abuts shoulder 48b as shown in FIG. 2j. The control shaft 42 has now been axially retracted such that the grip face 58 is axially spaced from end 88b by distance 90′ and the end 49 is axially flush or slightly recessed with end 88a. This is considered to be a “retracted position” of the control shaft 42 with respect to the axle sleeve 84, with direction 89′ considered to be a “retracting direction”. Within the range between extended and retracted positions, the resistance to axial displacement between the combined assembly 53 and axle sleeve 53 is greater than any resistance to axial displacement between the combined assembly 53 and control shaft 42. These positions and directions correspond to the aforementioned U.S. Pat. No. 6,089,675 which provides reference to the advantageous and functional aspects thereof.

Further displacement of the control shaft 42 in direction 89′ will be resisted by the frictional gripping engagement interface between the combined assembly 53 and opening 85. Thus, the control shaft 42 is axially retained to the axle sleeve 84 to restrain further displacement in the retracting direction 89′. The frictional gripping engagement interface also provides a tactile feedback and limit stop to the axial displacement of the control shaft 42 in direction 89′ to alert the user that the control shaft 42 is now in the retracted position. If the user wishes to further displace the control shaft in direction 89′, perhaps to withdraw the control shaft assembly 40 from the axle sleeve 84 as shown in FIG. 2h, then the user merely needs to forcibly press the control shaft 42 in direction 89′, pressing shoulder48b against end 51of spring clip 50b and overcoming the aforementioned engagement interface to drag the combined assembly 53 through the opening 85 and beyond end 88b.

If the spring clip 50b were omitted from the control shaft assembly 40, the spring clip 50a would still serve to provide a frictional engagement interface with the interior surface 95 of opening 85 to resist and restrain axial displacement between the spring clip 50a and axle sleeve 84. However, the inclusion of the second spring clip 50b serves to double or otherwise increase the effective frictional engagement interface between the combined assembly 53 and axle sleeve 84. Given the geometric constraints of conventional hub assemblies 80, frame interface (not shown), control shaft dimensions, and others, it may be difficult to design the spring clip 50a to provide a friction interface that will yield sufficient restraining resistance to this axial displacement to provide a positive tactile axial limit-stop feel for the user. Thus, it is highly advantageous to utilize two nested spring clips 50a and 50b as shown in FIGS. 2a-j. It is also advantageous that the two nested spring clips 50a and 50b are axially nested, with axially staggered spring fingers, since this minimizes the axial width 32 of the combined assembly 53 and also axially interlocks spring clips 50a and 50b such that they move axially (and circumferentially) as a single unit (i.e. combined assembly 53).

FIGS. 2k-L describe an alternative arrangement to the embodiment of FIGS. 2a-j where all components are identical to those described in FIGS. 2a-j with the exception that control shaft 42′ includes a relief 46′ with a narrower width 30′ between shoulders 48a ′ and 48b ′. Width 30′ is sized only slightly larger than width 32 to provide axial assembly clearance between combined assembly 53 and relief 46′. As such, upon assembly with the hub assembly 80, there is no appreciable free axial displacement of the control shaft 42′ as otherwise provided by gap 67. Instead, axial displacement between the control shaft 42′ and axle sleeve 84 requires that the friction engagement interface of the combined assembly 53 be forcibly dragged in directions 89 and 89′ to achieve the distances 90 and 90′ shown in FIGS. 2i-j. Due to radial clearance 65 between the combined assembly 53 and the diameter 47′, the control shaft 42′ may be free to rotate within combined assembly 53 about axial axis 28 as also described hereinabove.

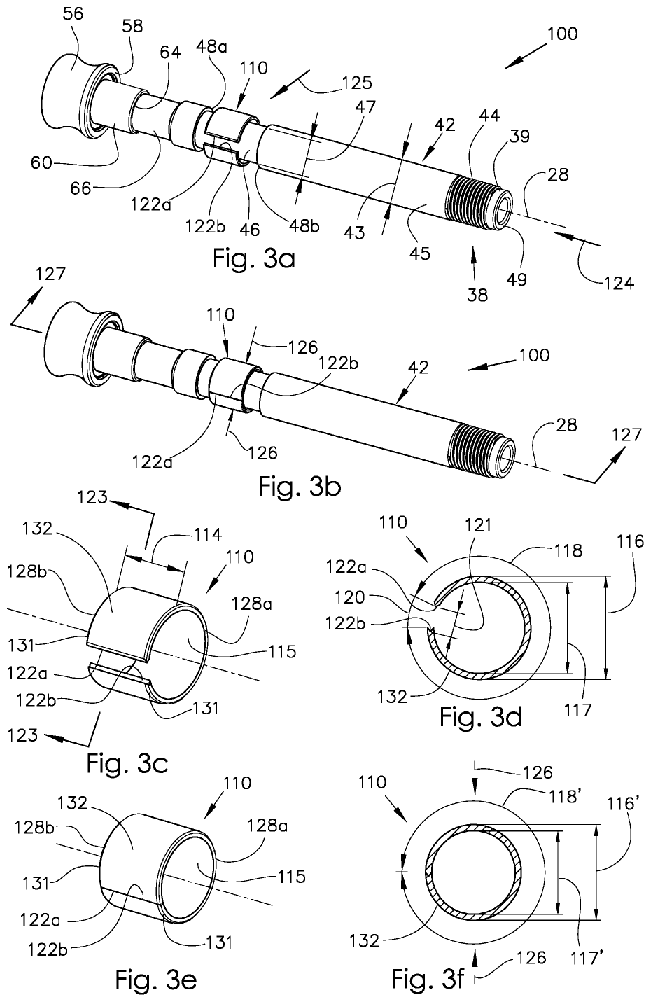

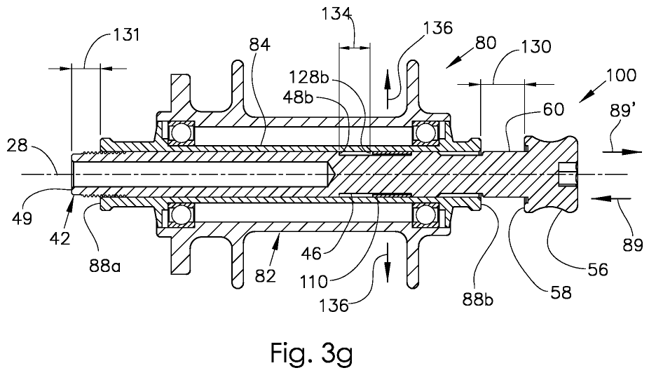

FIGS. 3a-g describe an embodiment where a flex sleeve 110 is substituted for the combined assembly 53 of FIGS. 2a-j to create control shaft assembly 100 that has similar functionality and interface with the axle sleeve 84. Control shaft 42 and hub assembly 80 are identical to those shown in FIGS. 2a-j.

Flex sleeve 110 is an elastic element having a well known “split sleeve” configuration with a single split. Flex sleeve 110 is shown in FIGS. 3a, 3c, and 3d in its relaxed and “open” position and is a circumferential tubular element having an axial width 114 between ends 128a and 128b, an outside diameter 116, an inside diameter 117, a circumferential wrap angle 118, a circumferential gap angle 120 that provides a gap 121 between ends 122a and 122b, which are the circumferential termini of the flex sleeve 110. End 122a is shown to have an axially extending convex pointed ridge profile and end 122b is shown to have an axially extending concave pointed groove profile. Lead-in chamfers 131 are preferably included at the intersections between each of ends 128a and 128b and the outboard surface 132 of flex sleeve 110. Flex sleeve 110 may be made from any of a variety of materials. One candidate material is a polymer material that may be economical and effective.

Flex sleeve 110 may be temporarily enlarged and opened to elastically expand circumferential gap121 to increase the inside diameter 117, allowing the flex sleeve 110 to be axially assembled in direction 124 along the shank portion 45 of the control shaft 40 to be aligned with relief 46 as shown in FIG. 3a. Alternatively, Flex sleeve 110 may be further enlarged and opened to be radially assembled in the radial direction 125 to be aligned with relief 46 as shown in FIG. 3a.

As shown in FIGS. 3b, 3e, and 3f. Flex sleeve 110 may be circumferentially flexed and manipulated to the “closed” position to close circumferential gap 121, thus reducing the outside diameter 116 and inside diameter 117 to the point where end 122a circumferentially abuts end 122b, with the convex pointed ridge profile of end 122a radially aligned and nested with the concave pointed groove profile of end 122b as shown. With the flex sleeve 110 in the closed position, the radial envelope of flex sleeve 110 is correspondingly reduced to a smaller inside diameter 117′ and outside diameter 116′ such that outside diameter 116′ is slightly larger than diameter 43 and the inside diameter 117′ is larger than diameter 47 to have radial clearance with relief 46.

The flex sleeve 110 is first axially positioned within relief 46 such that end 128b is radially overlapping and facing shoulder 48a and end 128a is radially overlapping and facing shoulder 48b as shown in FIG. 3a. The flex sleeve 110 may be further opened and stretched to permit this assembly with the relief 46. The flex sleeve 110 is next flexed to the closed position shown in FIG. 3b, gap angle 120 and corresponding gap 121 are eliminated such that wrap angle 118′ is now wrapped a full 360 degrees about axial axis 28, fully circumscribing the relief 46.

The circumferentially abutting interface between ends 122a and 122b shown in FIGS. 3b, 3e, and 3f may be considered a circumferential seam, split, discontinuity, or interruption of this full 360 degrees as viewed along the axial axis 28 , creating a “circumferential discontinuity” as described hereinabove. However, the contact and abutting of ends 122a and 122b shown in FIGS. 3e-g serve to close the space 120 to provide that the flex sleeve 110 to fully circumscribe and circumferentially surround the relief 46 as viewed along the axial axis 28. The optional nested contours of ends 122a and 122b serve to maintain their radial alignment to each other.

FIG. 3b shows the control shaft assembly 100 in preparation for assembly with the hub assembly 80. Next, to assemble the control shaft assembly 100 to the axle sleeve 84, control shaft assembly 100 must be pressed in direction 89 (with flex sleeve 110 in the closed position) so that shoulder 48a axially abuts and drives end 128a of flex sleeve 110 such that the chamfer 87 serves as a funnel to wedge against chamfer 131 until the flex sleeve 110 yields to elastically deflect, deform, and flex radially inwardly, pressing ends 122a and 122b against each other and further shrinking and reducing the outside diameter 116′ and inside diameter 117′ through circumferential hoop deformation of the flex sleeve 110. The control shaft assembly 100 is then further forced and pushed in direction 89 to push and drag the flex sleeve 110 within the opening 85 to the position shown in FIG. 3g. The grip face 58 is now axially spaced from end 88b by distance 130 and the end 49 is axially protruding from end 88a by distance 131. This is considered to be an “extended position” of the control shaft 42 with respect to the axle sleeve 84.

FIG. 3g shows the control shaft assembly 40 as inserted in direction 89 within opening 85. Since diameter 86 is smaller than outside diameter 116′, there is a radial interference between the diameters 116′ and 86, requiring a press or force or interference fit between the flex sleeve 110 and the opening 85 upon the assembly shown in FIG. 3g. Thus, as the control shaft assembly 110 is inserted and axially displaced within opening 85, there is first the free insertion of the shank portion 45 in direction 89 until the end face 128b contacts the chamfer 87. Next, the control shaft assembly 100 must be pressed in direction 89 so that shoulder 48a axially abuts and drives end face 128a such that the chamfer 87 serves to wedge against chamfer 131 until the flex sleeve 110 yields, by circumferential compression or hoop deflection to elastically deflect, deform, and flex radially inwardly. The control shaft assembly 100 is then further forced and pushed in direction 89 to push and drag the combined assembly 53 within the opening 85 to the position shown in FIG. 3g.

When flex sleeve 110 has been elastically deformed such that outside diameter 116′ is reduced to conform to the interior diameter 86 dimension of opening 85, an interference fit between the flex sleeve 110 and opening 85 is created and the control shaft assembly 100 can be further pressed in direction 89 to pass axially within opening 85 as shown in FIG. 3g. Due to the hoop deflection of flex sleeve 110 against opening 85, outside diameter 116′ is reduced to conform to the diameter 86 of opening 85, there is a residual spring-back energy and restoring force of the flex sleeve 110 in a direction opposed to its deformation. This restoring force serves to radially outwardly press exterior surface 132 against the interior surface 95 of opening 85 at the interface where these two surfaces contact. The result is a frictional engagement interface between exterior surface 132 and the interior surface 95 of opening 85. Flex sleeve 110 may be considered an engagement element that is axially retained to the control shaft 42 and is engaged to the axle sleeve 84 at an engagement interface to axially retain the control shaft 42 to the axle sleeve 84. This engagement interface provides a resistance and restraint to displacement of the flex sleeve 110 in both axial and circumferential directions relative to axle sleeve 84.

Due to the hoop deflection of flex sleeve 110 against opening 85, the exterior surface 132 presses radially outwardly in direction 136 against the interior surface 95 of opening 85, creating friction at a frictional gripping engagement interface therebetween as shown in FIG. 3g. While the hoop deflection of flex sleeve 110 may cause the radial thickness 113 to swell slightly, it may be considered that flex sleeve 110 is a generally radially rigid element where the radial thickness 113 between the interior surface 115 and exterior surface 132 does not appreciably change due to the aforementioned elastic deflection. Further, flex sleeve 110 has sufficient stiffness to maintain the engagement interface and to be considered as “radially self-supporting” such that the aforementioned elastic deflection of flex sleeve 110 occurs within the flex sleeve 110 itself and does not rely on internal radial support where interior surface 59 would otherwise brace or bear against the relief 46 of the control shaft 42.

In an alternate arrangement, the flex sleeve would only be “partially radially self supporting” where the radially inward deflection of the flex sleeve 110 would cause the interior surface 115 to contact and press lightly against the relief 46 to impart a light friction at interface where they contact. However, this light friction at internal surface 115 is significantly less than the aforementioned frictional engagement interface between exterior surface 132 and the interior surface 95 of axle sleeve 84 such that the flex sleeve 110 will not circumferentially rotate with the control shaft 42.

Thus, the flex sleeve 110 is retained with the axle sleeve 84 in both the axial and circumferential directions by this frictional engagement interface. Since the flex sleeve 110 is axially retained between shoulders 48a and 48b, the control shaft 42 is now also retained to the axle sleeve 84. However, because there remains a radial clearance between inside diameter 117 and the relief 46, the control shaft 42 is free to circumferentially rotate within the flex sleeve 110 and the axle sleeve 84. The control shaft assembly 100 is axially positioned within the axle sleeve 84 as shown in FIG. 3g, which corresponds to the extended position of the control shaft 42. The control shaft 42 may be further manipulated and interfaced with respect to the axle sleeve 84 in the manner identical to that described hereinabove with respect to FIGS. 2i-j.

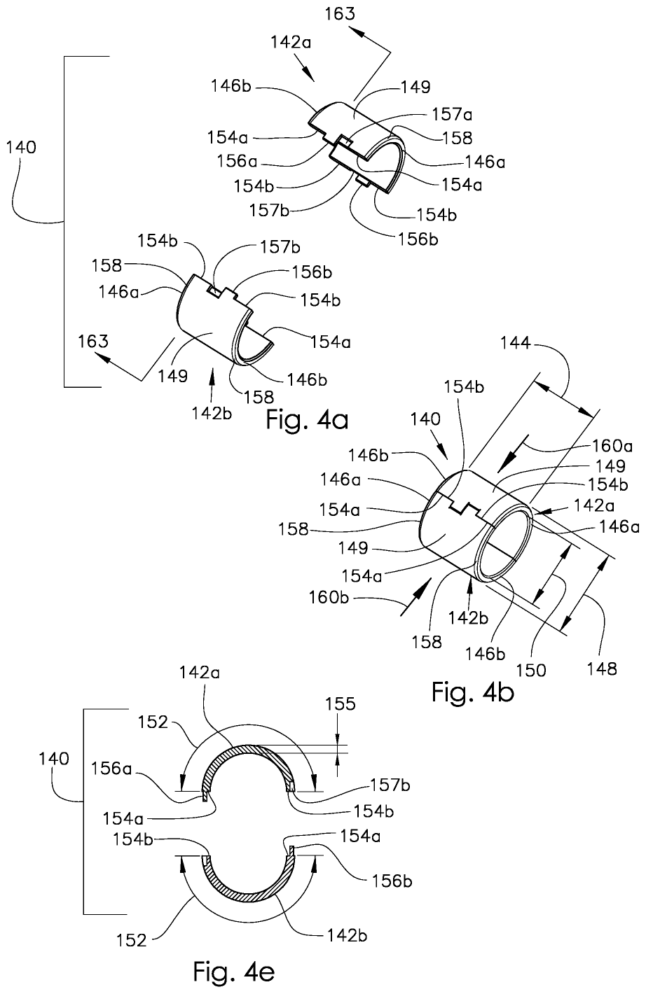

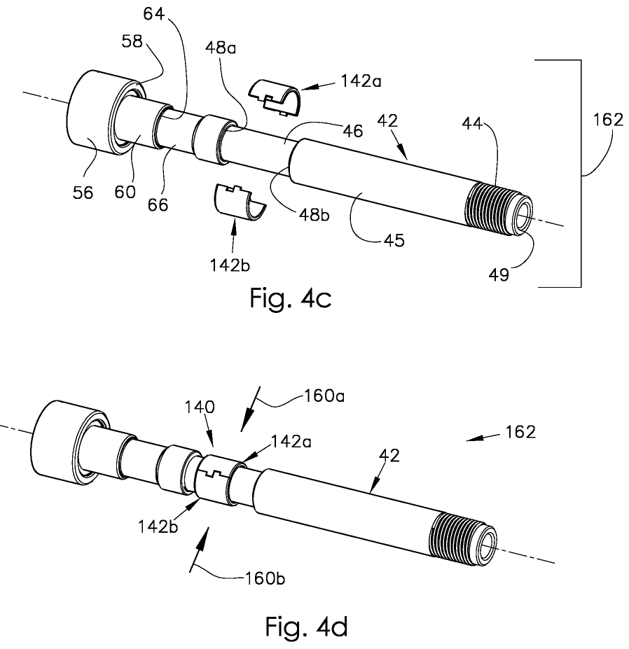

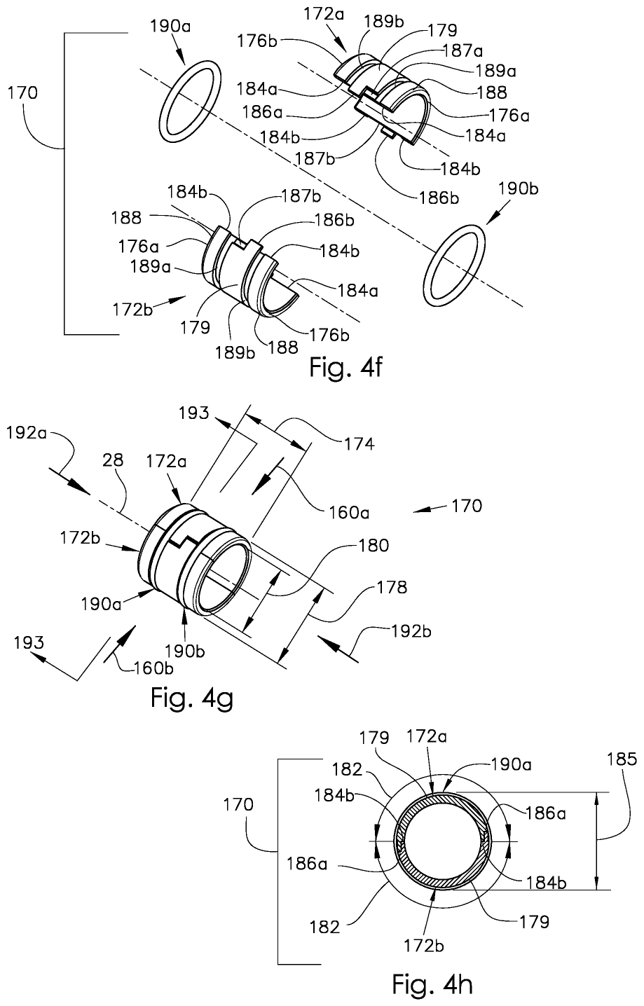

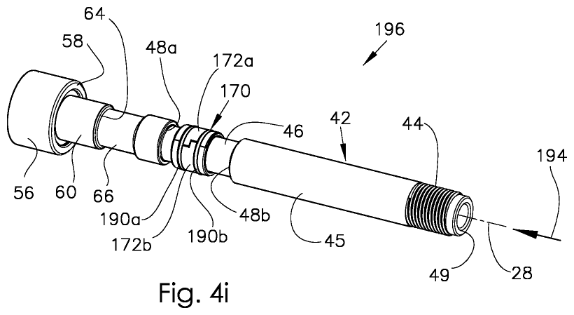

FIGS. 4a-d describe an embodiment where a combined assembly 140 of two identical split sleeves 142a and 142b is substituted for the combined assembly 53 of FIGS. 2a-j to create control shaft assembly 162 that has similar functionality and interface with the axle sleeve 84. Control shaft 42 and hub assembly 80 are identical to those shown in FIGS. 2a-j.

Combined assembly 140 is schematically similar to a well known “split sleeve” configuration having two semi-circular sleeves that include with a two splits. Split sleeve 142a is a generally semi-circular cylindrical element having an axial width 144 between ends 146a and 146b, an outside diameter 148 across its exterior surface 149, an inside diameter 148, a circumferential wrap angle 152 between split faces 154a and 154b, which are the circumferential termini of the split sleeve 142a. Split face 154a is optionally shown to have a circumferentially extending tab 156a and a relief 157a axially spaced therefrom. Split face 154b is shown to have a circumferentially extending tab 156b and a relief 157b axially spaced therefrom. A lead-in chamfer 158 is included at the intersection between each of split faces 154a and 154b and the exterior surface 149 of split sleeve 142a. Split sleeve 142a may be made from any of a variety of materials. One candidate material is a polymer material that may be economical and effective. Split sleeve 142b is identical to split sleeve 142a.

As shown in FIGS. 4a, 4e, and 4c, split sleeves 142a and 142b are positioned in a spread face-to-face orientation where split face 154a of split sleeve 142a faces split face 154b of split sleeve 142b and split face 154b of split sleeve 142a faces split face 154a of split sleeve 142b. Next, split sleeves 142a and 142b may be radially assembled, in respective directions 160a and 160b and in face-to-face orientation, to the relief 46 of control shaft 42 as shown in FIG. 4d. FIG. 4b shows this combined assembly 140 as assembled, but with the control shaft 42 omitted for explanatory purposes. Tab 156a of split sleeve 142a is now nested and engaged with relief 157b of split sleeve 142b for axial and radial alignment and registration therebetween. Similarly, tab 156b of split sleeve 142a is nested and engaged with relief 157a of split sleeve 142b for axial and radial alignment and registration therebetween. Tab 156a of split sleeve 142a is shown in FIGS. 4b and 4d to be axially offset and circumferentially overlapping tab 156b of split sleeve 142b. End faces 154a and 154b abut each other to limit any circumferential displacement between split sleeves 142a and 142b. The outside diameter 148 of the combined assembly 140 is larger than the diameter 43 of shank portion 45 and also slightly larger than the diameter 86 of opening 85. The inside diameter 150 of the combined assembly 140 is smaller than the diameter 43 of shank portion 45 and larger than the diameter 47 of relief 46. Thus, the combined assembly 140 is shown to be assembled around relief 46 and axially retained between shoulders 48a and 48b of the control shaft 42. With split sleeves 142a and 142b assembled together in the combined assembly 140 as shown in FIGS. 4b and 4d, the combined wrap angles 152 of split sleeves 142a and 142b equal a full 360 degrees about axial axis 28 to fully circumscribe the relief 46. It may be considered that the inclusion of tabs 156a and 156b, which circumferentially overlap the mating reliefs 157a and 157b, serves to increase the effective wrap angle even further than the wrap angle 152. As shown in FIG. 4d, the control shaft assembly 162 includes the control shaft 42 and the combined assembly 140 assembled to circumscribe the relief 46 about axial axis 28.

The circumferentially abutting split faces 154a and 154b and circumferential overlap of tabs 156a and 156b with their respective mating reliefs 157a and 157b, as shown in FIGS. 4b and 4d may be considered a circumferential seam, discontinuity, or interruption of this 360 degrees as viewed along a single radial plane, creating a “circumferential discontinuity” as described hereinabove. However, the contact and abutting of split faces 154a and 154b shown in FIGS. 4b and 4d provide that the combined assembly 140 fully circumscribes the relief 46 and circumferentially surrounds the axial axis 28 as viewed along the axial axis 28. The optional nested contours of tabs 156a and 156b with respective reliefs 157a and 157b serve to maintain the radial and axial alignment between split sleeves 142a and 142b.

Next, the assembly of the control shaft assembly 162 to the axle sleeve 84 is identical to that described in the embodiment of FIGS. 3a-3g. Control shaft assembly 162 must be pressed in direction 89 so that shoulder 48a axially abuts and drives end 146b of split sleeve 142a and end 146a of split sleeve 142b such that the chamfer 87 serves to wedge against chamfer 158 until the combined assembly 140 yields elastically to deflect and flex radially inwardly, pressing split faces 154a and 154b against each other and further shrinking and reducing the outside diameter 148 and inside diameter 150 by circumferential hoop deformation of the combined assembly 140. The control shaft assembly 162 is then further forced and pushed in direction 89 to push and drag the combined assembly 140 within the opening 85 to a position corresponding to that shown in FIG. 3g. The grip face 58 is now axially spaced from end 88b by distance 130 and the end 49 is axially protruding from end 88a by distance 131. This is considered to be an “extended position” of the control shaft 42 with respect to the axle sleeve 84.

When combined assembly 140 has been elastically deformed such that outside diameter 148 is reduced to conform to the interior diameter 86 dimension of opening 85, an interference fit between the combined assembly 140 and opening 85 is created and the control shaft assembly 162 can be further pressed in direction 89 to pass axially within opening 85 in a manner identical to that shown in FIG. 3g. Due to the hoop deflection and deformation of the combined assembly 140 against opening 85, outside diameter 148 is reduced to conform to the diameter 86 of opening 85, there is a residual spring-back energy and restoring force of the combined assembly 140 in a direction opposed to its deformation. This restoring force serves to radially outwardly press exterior surface 149 against the interior surface 95 of opening 85 at the interface where these two surfaces contact. The result is a frictional engagement interface between exterior surface 149 and the interior surface 95 of opening 85. Flex sleeve 140 may be considered an engagement element that is axially retained to the control shaft 42 and is engaged to the axle sleeve 84 at an engagement interface to axially retain the control shaft 42 to the axle sleeve 84. This engagement interface provides a resistance and restraint to displacement of the combined assembly 140 in both axial and circumferential directions relative to axle sleeve 84. Combined assembly 140 is considered to be both “radially rigid” and “radially self-supporting” as described herein above.

Thus, the combined assembly 140 is retained with the axle sleeve 84 in both the axial and circumferential directions by this frictional engagement interface. Since the combined assembly 140 is axially retained between shoulders 48a and 48b, the control shaft 42 is now also retained to the axle sleeve 84. However, because there remains a radial clearance between inside diameter 150 and the relief 46, the control shaft 42 is free to circumferentially rotate within the combined assembly 140 and the axle sleeve 84. The control shaft assembly 162 is axially positioned and assembled within the axle sleeve 84 in a manner identical to that shown in FIG. 3g, which corresponds to the extended position of the control shaft 42. The control shaft 42 may be further manipulated and interfaced with respect to the axle sleeve 84 in the manner identical to that described hereinabove with respect to FIGS. 2i-j.

FIGS. 4f-i describe an embodiment similar to the embodiment of FIGS. 4a-e with the exception that split sleeves 172a and 172b are substituted for split sleeves 142a and 142b and o-rings 190a and 190b are included to provide combined assembly 170 to create control shaft assembly 162 that has similar functionality and interface with the axle sleeve 84. Control shaft 42 and hub assembly 80 are identical to those shown in FIGS. 2a-j.

Split sleeve 172a is similar to split sleeve 142a and is also a generally semi-circular cylindrical element having an axial width 174 between ends 176a and 176b, an outside diameter 178 across its exterior surface 179, an inside diameter 180, a circumferential wrap angle 182 between split faces 184a and 184b, which are the circumferential termini of the split sleeve 172a. Split face 184a is shown to have a circumferentially extending tab 186a and a relief 187a axially spaced therefrom. Split face 184b is shown to have a circumferentially extending tab 186b and a relief 187b axially spaced therefrom. A lead-in chamfer 188 is included at the intersection between each of split faces 184a and 184b and the exterior surface 179 of split sleeve 172a. Split sleeve 172a may be made from any of a variety of materials. One candidate material is a polymer material that may be economical and effective. Unlike split sleeve 142a, split sleeve 172a further includes circumferential grooves 189a and 189b that are radially inwardly relieved from the exterior surface 179, with each serving as a partial gland to receive o-rings 190a and 190b respectively. Split sleeve 172b is identical to split sleeve 172a.

As shown in FIG. 4f, split sleeves 172a and 172b are positioned in a spread face-to-face orientation where end 174a of split sleeve 172a faces split face 154b of split sleeve 142b and end 174b of split sleeve 172a faces end 174a of split sleeve 172b. Next, split sleeves 172a and 172b may be radially assembled, in respective opposed directions 160a and 160b and in face-tg-h shows this combine assembly 170 as assembled, but with the control shaft 42 omitted for explanatory purposes. Tab 186a of split sleeve 172a is nested and engaged with relief 187b of split sleeve 172b for axial and radial alignment and registration therebetween. Similarly, tab 186b of split sleeve 172a is nested and engaged with relief 187a of split sleeve 172b for axial and radial alignment and registration therebetween. Groove 189a of split sleeve 172a is circumferentially and axially aligned with groove 189b of split sleeve 172b and groove 189b of split sleeve 172a is circumferentially and axially aligned with groove 189a of split sleeve 172b.

O-ring 190a is assembled in direction 192a to this pre-assembly of split sleeves 172a and 172b such that it is nested in groove 189a of split sleeve 172a and groove 189b of split sleeve 172b as shown. Similarly, o-ring 190b is assembled in direction 192b to be nested in groove189b of split sleeve 172a and groove 189a of split sleeve 172b as shown to complete the assembly of combined assembly 170. O-rings 190a and 190b may be of the convention type and made of elastic rubber such that they serve to radially and axially retain split sleeves 172a and 172b to each other. Next, the split sleeves 172a and 172b may be temporarily spread in a direction opposed to directions 160a and 160b, stretching o-rings 190a and 190b, and allowing the combined assembly 170 to be assembled in direction 194 over shank portion 45 to be assembled and seated in relief 46 as shown in FIG. 4i. O-rings 190a and 190b provide a retaining feature to radially retain split sleeves 172a and 172b to each other.

The inside diameter 180 of the combined assembly 170 is smaller than the diameter 43 of shank portion 45 and larger than the diameter 47 of relief 46. Thus, the combined assembly 170 is shown to be assembled around relief 46 and axially retained between shoulders 48a and 48b of the control shaft 42. With split sleeves 172a and 172b assembled together in the combined assembly 170 as shown in FIG. 4g, the combined wrap angles 182 of split sleeves 172a and 172b equal a full 360 degrees about axial axis 28 to fully circumscribe the relief 46 in a manner similar to that described in FIGS. 4a-e. As shown in FIG. 4i, the control shaft assembly 196 includes the control shaft 42 and the combined assembly 170 wrapped around the relief 46.

The abutting split faces 184a and 184b and circumferential overlap of tabs 186a and 186b with their respective mating reliefs 187a and 187b may be considered a circumferential seam, discontinuity, or split of this 360 degrees as viewed along a the axial axis 28 , creating a “circumferential discontinuity” as described hereinabove. However, the contact and abutting of split faces 184a and 184b shown in FIGS. 4g-i provide that the combined assembly 170 fully circumscribes the relief 46 and circumferentially surrounds the axial axis 28 as viewed along the axial axis 28. The optional nested contours of tabs 186a and 186b with respective reliefs 187a and 187b serve to maintain the radial and axial alignment between split sleeves 172a and 172b. O-rings 190a and 190b are continuous circumferential portions of the combined assembly 170 that wrap continuously about axial axis 28 without a circumferential discontinuity, split, or seam.

Next, the assembly of the control shaft assembly 196 to the axle sleeve 84 is identical to that described in the embodiment of FIGS. 3a-3g. In a first arrangement of the combined assembly 170, the outside diameter 178 of the combined assembly 170 may be larger than the diameter 43 of shank portion 45 and also slightly larger than the diameter 86 of opening 85 to provide an interference fit between combined assembly 170 and opening 85 as described in FIGS. 4a-e. Control shaft assembly 196 must be pressed in direction 89 so that shoulder 48a axially abuts and drives end face 176b of split sleeve 172a and end face 146a of split sleeve 172b such that the chamfer 87 serves to wedge against chamfer 188 until the combined assembly 170 yields elastically to deflect and flex radially inwardly, pressing split faces 184a and 184b against each other and further shrinking and reducing the outside diameter 178 and inside diameter 180 by circumferential hoop deformation of the combined assembly 170. The control shaft assembly 196 is then further forced and pushed in direction 89 to push and drag the combined assembly 170 within the opening 85 corresponding to an extended position corresponding to that shown in FIG. 3g.

When combined assembly 170 has been elastically deformed upon pressed assembly with the axle sleeve 84 such that outside diameter 178 is reduced to conform to the interior diameter 86 dimension of opening 85, an interference fit between the combined assembly 170 and opening 85 is created and the control shaft assembly 196 can be further pressed in direction 89 to pass axially within opening 85 in a manner identical to that shown in FIG. 3g. Due to the hoop deflection and deformation of the combined assembly 170 against opening 85, outside diameter 178 is reduced to conform to the diameter 86 of opening 85, there is a residual spring-back energy and restoring force of the combined assembly 170 in a direction opposed to its deformation. This restoring force serves to radially outwardly press exterior surface 179 against the interior surface 95 of opening 85 at the interface where these two surfaces contact. The result is a frictional engagement interface between exterior surface 179 and the interior surface 95 of opening 85. Combined assembly 170 may be considered an engagement element that is axially retained to the control shaft 42 and is engaged to the axle sleeve 84 at an engagement interface to axially retain the control shaft 42 to the axle sleeve 84. Combined assembly 170 is considered to be both “radially rigid” and “radially self-supporting” as described herein above.

In a first alternate arrangement of the combined assembly 170, the outside diameter 178 may be smaller than inside diameter 86 of sleeve assembly 84 and the depth of grooves 189a and 189b are sized such that the installed outer diameter 185 of o-rings 190a and 190b are larger than outside diameter 178 such that o-rings 190a and 190b are radially outboard or proud of exterior surface 179. Outside diameter 185 is larger than the diameter 86 of opening 85 to provide an interference fit between combined assembly 170 and opening 85 as described in FIGS. 4a-e. Again, control shaft assembly 196 must be pressed in direction 89 so that shoulder 48a axially abuts and drives end face 176b of split sleeve 172a and end face 146a of split sleeve 172b such that the chamfer 87 serves to wedge against the surface of o-ring 190b (and then o-ring190a) until the o-ring 190b (and then o-ring190a) of the combined assembly 170 squashes and yields elastically, reducing the outside diameter 185 and by distorting the cross section of o-rings 190a and 190b. The control shaft assembly 196 is then further forced and pushed in direction 89 to push and drag the combined assembly 170 within the opening 85 corresponding to an extended position corresponding to that shown in FIG. 3g.

O-rings 190a and 190b may be made of a soft elastomeric material such as rubber which may have a high coefficient of friction that is greater than the coefficient of friction of split sleeves 172a and 172b. Thus, the interference fit contact between o-rings 190a and 190b and the interior surface 95 may have an increased level of friction relative to the first arrangement as described hereinabove. Simultaneously, the root of grooves 189a and 189b support the inside diameter surface of o-rings 190a and 190b such that the inside diameter 180 does not shrink appreciably due to this interference fit, permitting radial clearance with the relief 46 as described hereinabove.

While o-rings 190a and 190b might not have the attribute of being radially self supporting as described hereinabove, however, the split sleeves 172a and 172b do have this attribute. As such, the inside diameter of o-rings 190a and 190b may bear and brace against the split sleeves 172a and 172b, but without bearing and bracing against the relief 46 of control shaft 42. As such, the combined assembly 170 is still considered to be radially self supporting as described hereinabove.

In a second alternate design, both the outside diameter 178 of split sleeves 172a and 172b and the outside surface of o-rings 190a and/or 190b may be larger than the diameter 86 of opening 85 such that the aforementioned interference fit will include frictional contact between the interior surface 95 and both the exterior surfaces 179 and the o-rings 190a and 190b.The resulting control shaft assembly 196 may be assembled to the hub assembly 80 in a manner identical to that described in FIG. 3g. The rubber o-rings 190a and 190b may deform against the interior of opening 85 to provide additional friction at the frictional engagement interface between the combined assembly 170 and the opening 85. The rubber o-ring material of o-rings 190a and 190b has a very high coefficient of friction, which provides an enhanced frictional engagement interface between the combined assembly 170 and the opening.

In the aforementioned first arrangement , the first alternate design, and the second alternate design, the combined assembly 170 is retained with the axle sleeve 84 in both the axial and circumferential directions by this frictional engagement interface. Since the combined assembly 170 is axially retained between shoulders 48a and 48b, the control shaft 42 is now also retained to the axle sleeve 84. However, because there remains a radial clearance between inside diameter 180 and the relief 46, the control shaft 42 is free to circumferentially rotate within the combined assembly 170 and the axle sleeve 84. The control shaft assembly 196 is axially positioned and assembled within the axle sleeve 84 in a manner identical to that shown in FIG. 3g, which corresponds to the extended position of the control shaft 42. The control shaft 42 may be further manipulated and interfaced with respect to the axle sleeve 84 in the manner identical to that described hereinabove with respect to FIGS. 2i-j.

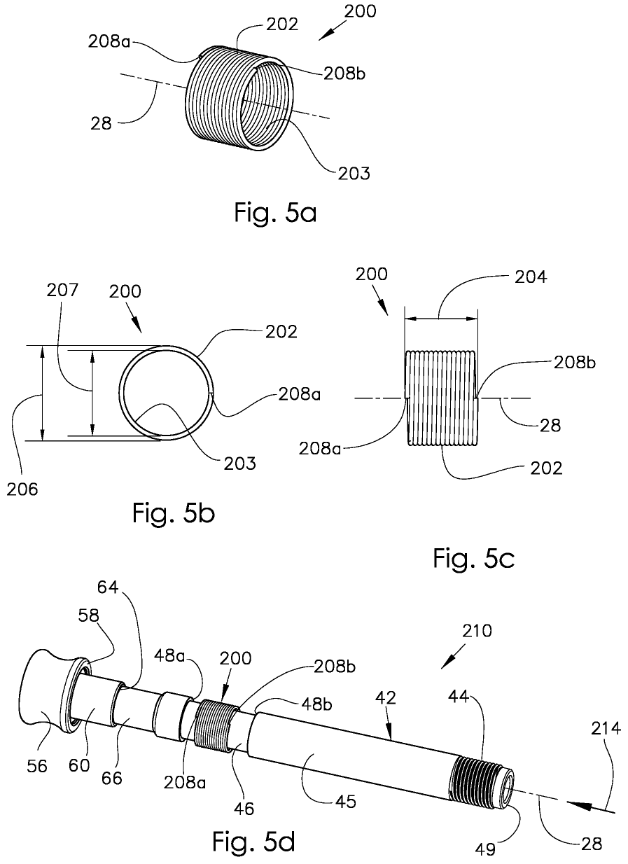

FIGS. 5a-d describe an embodiment where a helical coil 200 is substituted for the combined assembly 53 of FIGS. 2a-j to create control shaft assembly 210 that has similar functionality and interface with the axle sleeve 84. Control shaft 42 and hub assembly 80 are identical to those shown in FIGS. 2a-j.

Coil 200 is an elastic element created by a helical coil of wire, such as hardened steel wire similar to the construction of a coil spring that is well known in industry. Coil 200 is shown in FIGS. 5a-d in its relaxed state and is a circumferential cylindrical element having an axial width 204 between ends 208a and 208b, an outside diameter 206, an inside diameter 207. The wire of coil 200 is wrapped in a helical configuration about axial axis 28 such that its circumferential wrap angle is equal to the number of “turns” of the helix, where each turn is a 360 degree wrap of wire. In other words, the coil 200 is composed of axially stacked turns of wire that circumferentially overlap each other such that the circumferential wrap angle is much greater than 360 degrees. Exterior surface 202 is defined by the radially outboard surfaces of the individual turns or loops of the coil 200. Interior surface 203 is defined by the radially inboard surfaces of the individual turns or loops of the coil 200.

Coil 200 may be temporarily enlarged, expanded, and opened by twisting ends 208a and 208b relative to each other to elastically increase the inside diameter 207, allowing the coil 200 to be axially assembled in direction 214 along the shank portion 45 of the control shaft 40 to be aligned with relief 46 as shown in FIG. 5d. When the coil 200 is axially aligned with the relief 46, the twisting force is removed and the coil 200 elastically returns to its relaxed state. Alternatively, the control shaft 42 may be made of multiple parts, that allow the control shaft to be temporarily separated to permit assembly of the coil 200 to the relief 46 without requiring the aforementioned radial expansion.

The relaxed coil 200 is axially overlapping and positioned within relief 46 such that end 208a is radially overlapping and facing adjacent shoulder 48a and end 208b is radially overlapping and facing adjacent shoulder 48b. The outside diameter 206 of the coil 200 is larger than the diameter 43 of shank portion 45 and also slightly larger than the diameter 86 of opening 85. The inside diameter 207 of the coil 200 is smaller than the diameter 43 of shank portion 45 and larger than the diameter 47 of relief 46. The relaxed coil 200 is axially overlapping and positioned within relief 46 such that end 208a is radially overlapping and facing adjacent shoulder 48a and end 208b is radially overlapping and facing adjacent shoulder 48b. Coil 200 is axially retained and captured between shoulders 48a and 48b to create control shaft assembly 210. The ends 212a and 212b may be considered a circumferential discontinuities, ends, or interruptions. Further, the helical split between the helical wire may also be considered as a circumferential discontinuity, particularly since it extends along the entire axial width 204 of the coil 200. The circumferential helical overlap of coil 200 insures that it fully circumscribes the relief 46 and circumferentially surrounds the axial axis 28 as viewed along the axial axis 28.

Next, the assembly of the control shaft assembly 210 to the axle sleeve 84 is identical to that described in the embodiment of FIGS. 3a-3g. The control shaft assembly 210 is pressed in direction 89 so that shoulder 48a axially abuts and drives end 208a of coil 200 such that the chamfer 87 serves to wedge against end 208b and the remainder of coil 200 as the turns of coil 200 successively yield elastically to deflect and flex radially inwardly, further shrinking and reducing the outside diameter 206 and inside diameter 207 by radial bending deformation of the coil 200. The control shaft assembly 210 is then further forced and pushed in direction 89 to push and drag the coil 200 within the opening 85 to the position corresponding to the position of sleeve 110 shown in FIG. 3g and corresponding to the position of combined assembly 53 shown in FIG. 2j. The grip face 58 is now axially spaced from end 88b by distance 130 and the end 49 is axially protruding from end 88a by distance 131. This is considered to be an “extended position” of the control shaft 42 with respect to the axle sleeve 84.

When the coil 200 has been elastically deflected and deformed such that its outside diameter 206 is reduced to conform to the interior diameter 86 dimension of opening 85, an interference fit between the coil 200 and opening 85 is created and the coil 200 can be further pressed in direction 89 to pass axially within opening 85 in a manner identical to that described in FIG. 3g. This bending deflection imparts an elastic preload on the coil 200, which creates a radially outward spring-back energy and restoring force in direction 136. This restoring force serves to radially outwardly press exterior surface 202 against opening 85 at the interface where these two surfaces contact. The result is a frictional engagement interface between exterior surface 202 and the interior surface 95 of opening 85. Coil 200 may be considered an engagement element that is axially retained to the control shaft 42 and is engaged to the axle sleeve 84 at an engagement interface to axially retain the control shaft 42 to the axle sleeve 84. This engagement interface provides a resistance and restraint to displacement of the coil 200 in both axial and circumferential directions relative to axle sleeve 84.

Since the coil 200 is axially retained between shoulders 48a and 48b, the control shaft 42 is now also retained to the axle sleeve 84. However, because there remains a radial clearance between inside diameter 207 and the relief 46, the control shaft 42 is free to circumferentially rotate within the coil 200 and the axle sleeve 84. Coil 200 is considered to be both a radially rigid and radially self supporting element as described hereinabove. Finally, The control shaft 42 may be further manipulated and interfaced with respect to the axle sleeve 84 in the manner identical to that described hereinabove with respect to FIGS. 2i-j.

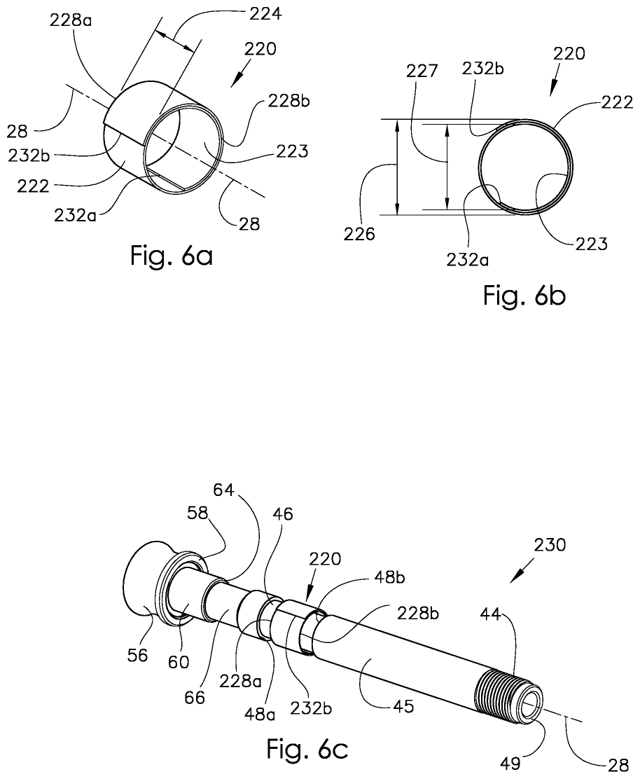

FIGS. 6a-c describe an embodiment where a spiral coil 200 is substituted for the combined assembly 53 of FIGS. 2a-j to create control shaft assembly 230 that has similar functionality and interface with the axle sleeve 84. Control shaft 42 and hub assembly 80 are identical to those shown in FIGS. 2a-j.

Coil 220 is an elastic element created by a spiral coil of flat material such as hardened steel sheet similar to the construction of coiled spring pins known in industry. Coil 220 is shown in FIGS. 6a-c in its relaxed state and is a circumferential cylindrical element having an axial width 224 between ends 228a and 228b, an outside diameter 226, an inside diameter 227. Ends 232a and 232b are the respective radially inboard and outboard terminations of the circumferentially wrapped material of the coil 220. The coil 220 is wrapped in a spiral configuration about axial axis 28 such that its circumferential wrap angle is equal to the number of “turns” of the spiral, where each turn is a 360 degree wrap. In other words, the coil 220 is composed of a radially stacked (i.e. radially offset) and overlapping turns of material, such that the circumferential wrap angle is much greater than 360 degrees. Exterior surface 222 is defined by the radially outboard and exposed turn of the coil 220. Interior surface 223 is defined by the radially outboard and exposed turn of the coil 220.

Coil 220 is installed on control shaft 42 to circumferentially circumscribe and axially overlap relief 46 as shown in FIG. 6c to create control shaft assembly 230. The outside diameter 226 of the coil 220 is larger than the diameter 43 of shank portion 45 and also slightly larger than the diameter 86 of opening 85. The inside diameter 227 of the coil 220 is smaller than the diameter 43 of shank portion 45 and larger than the diameter 47 of relief 46. The relaxed coil 220 is axially overlapping and positioned within relief 46 such that end 228a is radially overlapping and facing adjacent shoulder 48a and end 228b is radially overlapping and facing adjacent shoulder 48b. Coil 220 is axially retained and captured between shoulders 48a and 48b to create control shaft assembly 210. The ends 232a and 232b may be considered a circumferential discontinuities, ends, or interruptions as viewed along a single radial plane. Further, the spiral split between the adjacent turns of spirally wrapped flat material may also be considered as a circumferential discontinuity, particularly since it extends along the entire axial width 224 and circumference of the coil 220. Coil 220 fully circumscribes the relief 46 and circumferentially surrounds the axial axis 28 as viewed along the axial axis 28.

Next, the control shaft assembly 230 is assembled to the axle sleeve 84 in a procedure similar to that described in FIGS. 2g-j. The control shaft assembly 230 is pressed in direction 89 so that shoulder 48a axially abuts and drives end 228a of coil 220 such that the chamfer 87 serves to wedge against end 228b until the coil 220 yields elastically to deflect and flex radially inwardly and further shrinking and reducing the outside diameter 206 and correspondingly reducing inside diameter 207 by circumferential deformation of the coil 220. The control shaft assembly 230 is then further forced and pushed in direction 89 to push and drag the coil 220 within the opening 85 to the position corresponding to the position of sleeve 110 shown in FIG. 3g and corresponding to the position of combined assembly 53 shown in FIG. 2j. The grip face 58 is now axially spaced from end 88b by distance 130 and the end 49 is axially protruding from end 88a by distance 131. This is considered to be an “extended position” of the control shaft 42 with respect to the axle sleeve 84.

When the coil 220 has been elastically deflected and deformed such that its outside diameter 226 is reduced to conform to the interior diameter 86 dimension of opening 85, an interference fit between the coil 220 and opening 85 is created and the coil 220 can be further pressed in direction 89 to pass axially within opening 85 in a manner identical to that described in FIG. 3g. This bending deflection imparts an elastic preload on the coil 200, which creates a radially outward spring-back energy and restoring force in direction 136. This restoring force serves to radially outwardly press exterior surface 222 against opening 85 at the interface where these two surfaces contact. The result is a frictional engagement interface between exterior surface 222 and the interior surface 95 of opening 85. Coil 220 may be considered an engagement element that is axially retained to the control shaft 42 and is engaged to the axle sleeve 84 at an engagement interface to axially retain the control shaft 42 to the axle sleeve 84. This engagement interface provides a resistance and restraint to displacement of the coil 220 in both axial and circumferential directions relative to axle sleeve 84.

Since the coil 220 is axially retained between shoulders 48a and 48b, the control shaft 42 is now also retained to the axle sleeve 84. However, because there remains a radial clearance between inside diameter 227 and the relief 46, the control shaft 42 is free to circumferentially rotate within the coil 220 and the axle sleeve 84. Coil 220 is considered to be both a radially rigid and radially self supporting element as described hereinabove. Finally, The control shaft 42 may be further manipulated and interfaced with respect to the axle sleeve 84 in the manner identical to that described hereinabove with respect to FIGS. 2i-j.

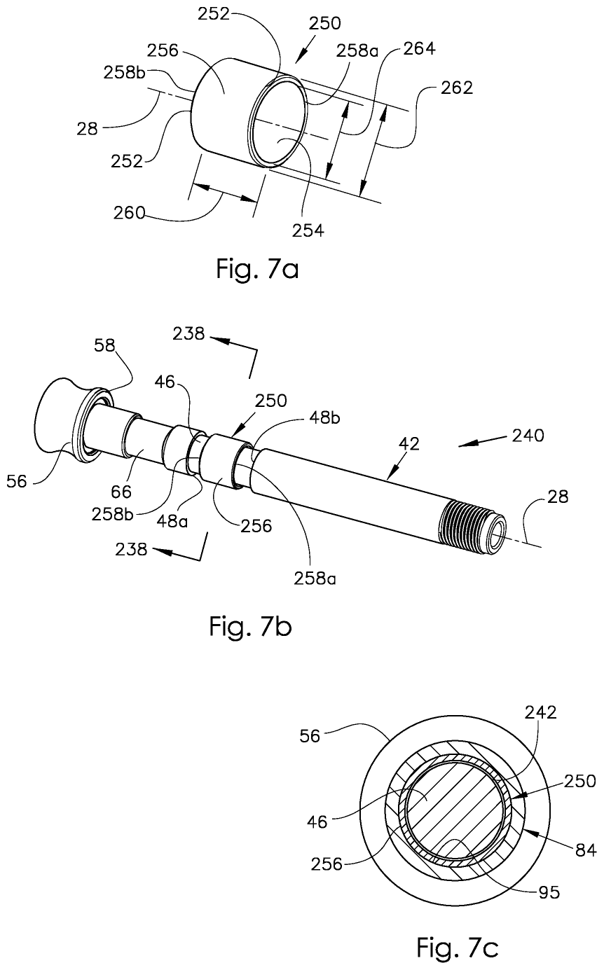

FIGS. 7a-c describe an embodiment where a sleeve 250 is substituted for the combined assembly 53 of FIGS. 2a-j to create control shaft assembly 240 that has similar functionality and interface with the axle sleeve 84. Control shaft 42 and hub assembly 80 are identical to those shown in FIGS. 2a-j.

Sleeve 250 is an elastic element having a cylindrical tube configuration. Sleeve 250 is similar to flex sleeve 110 of FIGS. 3a-g and has an axial width 260 between end faces 258a and 258b, an exterior surface 256, an interior surface 254, an outside diameter 262, and an inside diameter 264. Lead-in chamfers 252 are preferably included at the intersections between each of end faces 258a and 258b and the exterior surface 256 of sleeve 250. Flex sleeve 110 may be made from any of a variety of materials. One candidate material is a polymer material that may be economical and effective. Unlike sleeve 110, sleeve 250 does not include the split or circumferential discontinuity created by ends 122a and 122b. Since sleeve 250 does not have the circumferential discontinuity as described hereinabove, it is considered to be a circumferentially continuous element that fully circumscribes the axial axis 28.

As shown in FIGS. 7b-c, sleeve 250 has been assembled to be axially overlapping and fully circumscribing the relief 46 of the control shaft 42 to create control shaft assembly 240. Sleeve 250 is axially positioned within relief 46 such that end face 258b is radially overlapping and facing shoulder 48a and end 258a is radially overlapping and facing shoulder 48b as shown in FIG. 7b.

Next, the control shaft assembly 240 is assembled to the axle sleeve 84 in a manner identical to that described to that described in the embodiment of FIGS. 3a-3g. The control shaft assembly 240 is pressed in direction 89 so that shoulder 48a axially abuts and drives end face 258b such that the chamfer 87 serves as a funnel to wedge against chamfer 252 until the sleeve 250 yields to elastically deflect, deform, and flex radially inwardly and shrinking and reducing the outside diameter 116′ and inside diameter 117′ through circumferential hoop deflection (i.e. circumferential compressive deflection) of the sleeve 250. The control shaft assembly 240 is then further forced and pushed in direction 89 to push and drag the sleeve 250 within the opening 85 to the axial position corresponding to that of flex sleeve 110 shown in FIG. 3g. The grip face 58 is now axially spaced from end 88b by distance 130 and the end 49 is axially protruding from end 88a by distance 131. This is considered to be an “extended position” of the control shaft 42 with respect to the axle sleeve 84.

When the sleeve 250 has been elastically deflected and deformed such that its outside diameter 262 is reduced to conform to the interior diameter 86 dimension of opening 85, an interference fit between the sleeve 250 and opening 85 is created and the sleeve 250 can be further pressed in direction 89 to pass axially within opening 85 in a manner identical to that described in FIG. 3g. This hoop deflection imparts an elastic preload on the sleeve 250, which creates a radially outward spring-back energy and restoring force in the radially outwardly direction. This restoring force serves to radially outwardly press exterior surface 254 against opening 85 at the interface where these two surfaces contact. The result is a frictional engagement interface between exterior surface 254 and the interior surface 95 of opening 85. Sleeve 250 may be considered an engagement element that is axially retained to the control shaft 42 and is engaged to the axle sleeve 84 at an engagement interface to axially retain the control shaft 42 to the axle sleeve 84.

Since the sleeve 250 is axially retained between shoulders 48a and 48b, the control shaft 42 is now also retained to the axle sleeve 84. However, because there remains a radial clearance between the interior surface 254 and the relief 46, the control shaft 42 is free to circumferentially rotate within the sleeve 250 and the axle sleeve 84. Sleeve 250 is considered to be both a radially rigid and radially self supporting element as described hereinabove, although it is anticipated that the hoop deflection may cause a slight swelling of the radial thickness of sleeve 250. Finally, The control shaft 42 may be further manipulated and interfaced with respect to the axle sleeve 84 in the manner identical to that described hereinabove with respect to FIGS. 2i-j.

While my above description contains many specificities, these should not be construed as limitations on the scope of the invention, but rather as exemplifications of embodiments thereof. For example:

The embodiments are shown hereinabove show the engagement element to have a generally smooth exterior surface for interface with the generally smooth interior surface of the axle sleeve. However, the engagement element may alternatively have an exterior surface that includes generally roughened, textured, or otherwise configured for interface with the interior surface of the axle sleeve. As a further alternative, the interior surface of the axle sleeve may include a generally roughened, textured, or otherwise configured for interface with the exterior surface of the engagement element. Further, both the interior surface of the axle sleeve and the exterior surface of the engagement element may alternatively include a generally roughened, textured, or otherwise configured for interface therebetween. Yet further, both the interior surface of the axle sleeve and the exterior surface of the engagement element may alternatively be configured such that the configured interior surface of the axle sleeve mechanically interlocks with the exterior surface of the engagement element. The mechanical interlock provides a mechanical resistance to circumferential and/or axial displacement therebetween.

Additionally, the engagement element may alternatively include barbs or other geometric features that impinge and deboss the interior surface of the axle sleeve to create mechanical interlock and mechanical resistance to circumferential and/or axial displacement therebetween. Furthermore, the interior surface of the axle sleeve may alternatively include barbs or other geometric features that impinge and deboss the exterior surface of the axle sleeve to create mechanical interlock and mechanical resistance to circumferential and/or axial displacement therebetween.

While the embodiments herein describe a radial clearance between the interior surface of the engagement element and the relief of the control shaft after assembly of the control shaft assembly with the axle sleeve. This permits the free axial and/or circumferential displacement between the control shaft and the axle sleeve. However, the interior surface of the engagement element may alternatively have contact, either directly or indirectly, with the relief of the control shaft after assembly of the control shaft assembly with the axle sleeve. The control shaft may still be axially and/or circumferentially displaceable relative the axle sleeve so long as any resistance to such displacement is less than the resistance to axial and/or circumferential displacement between the engagement element and the axle sleeve at the engagement interface.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

What is claimed is:

1. A vehicle wheel axle assembly, comprising:
an axle sleeve that is rotationally stationary about an axial axis and that includes: a first end face; a second end face axially spaced from said first end face; and an axially extending opening therethrough;
a control shaft assembly including: (i) a control shaft including an engagement end and a control end axially opposed said engagement end; and (ii) an engagement element having an engagement surface; wherein said engagement element is axially retained to said control shaft (in an axially abutting engagement therebetween?);
wherein said control shaft assembly extends within said opening to be axially overlapping said axle sleeve with said engagement end proximal said first end face and distal said second end face;
wherein said engagement element has a restraining engagement with said axle sleeve at an engagement interface between said engagement surface and said opening; said restraining engagement serving to provide a restraining resistance to restrain axial displacement between said control shaft and said axle sleeve; and
wherein said engagement element fully circumscribes said control shaft about said axial axis; and
wherein said engagement element is radially self-supporting.

2. The vehicle wheel axle assembly according to claim 1, wherein said engagement element includes a circumferential discontinuity.

3. The vehicle wheel axle assembly according to claim 1, wherein said engagement element is a continuous circumferential element.

4. The vehicle wheel axle assembly according to claim 1, wherein a first portion of said engagement element is a continuous circumferential portion thereof and a second portion of said engagement element includes a circumferential discontinuity.

5. The vehicle wheel axle assembly according to claim 1, including an interference press fit between said engagement element and said opening, said interference press fit serving to restrain axial displacement between said engagement element and said opening.

6. The vehicle wheel axle assembly according to claim 1, wherein said engagement interface includes a frictional engagement interface.

7. The vehicle wheel axle assembly according to claim 2, wherein said engagement element includes a split sleeve with abutting ends having a circumferential wrap angle of 360 degrees to fully circumscribe said control shaft about said axial axis.

8. The vehicle wheel axle assembly according to claim 2, wherein said engagement element includes a multiplicity of circumferentially overlapping elements to provide a combined circumferential wrap angle of at least 360 degrees about said axial axis.

9. The vehicle wheel axle assembly according to claim 8, wherein said engagement element includes a first element thereof and a second element thereof, wherein said first element circumferentially overlaps said second element in an axially offset circumferential overlap.

10. The vehicle wheel axle assembly according to claim 9, wherein at least one of: (i) said first element is axially engaged to said second element to limit axial displacement therebetween, and (ii) said first element is circumferentially engaged to said second element to limit circumferential displacement therebetween.

11. The vehicle wheel axle assembly according to claim 2, wherein said circumferential discontinuity is a circumferentially abutting discontinuity including circumferentially abutting contact between a first portion of said engagement element and a second portion of said engagement element, wherein said first portion is monolithic with said second portion.

12. The vehicle wheel axle assembly according to claim 2, wherein said circumferential discontinuity is a circumferentially abutting discontinuity including circumferentially abutting contact between a first portion of said engagement element and a second portion of said engagement element, wherein said first portion is in an element discreet from said second portion.

13. The vehicle wheel axle assembly according to claim 2, wherein said engagement element includes a first portion thereof and a second portion thereof discreet from said first portion; wherein said discontinuity of said first portion includes a circumferential gap; wherein said second portion circumferentially overlaps said gap at a circumferential overlap region.

14. The vehicle wheel axle assembly according to claim 1, wherein said engagement element includes a first portion and a second portion thereof, said second portion circumferentially overlaps and is axially offset from said first portion.

15. The vehicle wheel axle assembly according to claim 1, wherein said engagement element includes a first portion and a second portion thereof, said second portion circumferentially overlaps and is radially offset from said first portion.

16. The vehicle wheel axle assembly according to claim 15, wherein said second portion includes high-friction material at said engagement interface to contact said opening and to augment said restraining engagement.

17. The vehicle wheel axle assembly according to claim 1, wherein said engagement element is a helical element such that said engagement element circumferentially overlaps itself in an axially offset overlap region.

18. The vehicle wheel axle assembly according to claim 1, wherein said engagement element is a spiral element such that said engagement element radially overlaps itself in a radially offset overlap region.

19. The vehicle wheel axle assembly according to claim 5, wherein said engagement element includes a radial thickness between said exterior surface and said interior surface, wherein said engagement element is radially rigid such that said radial thickness does not change appreciably due to said interference press fit.

20. The vehicle wheel axle assembly according to claim 1, wherein said control shaft includes a relieved portion that is axially flanked by a first shoulder and a second shoulder thereof, wherein said engagement element circumscribes said relieved portion and is axially retained between said first shoulder and said second shoulder.

21. The vehicle wheel axle assembly according to claim 1, wherein said engagement element includes an interior surface, including radial clearance between said interior surface and said control shaft.

22. The vehicle wheel axle assembly according to claim 1, wherein said restraining engagement serves to restrain circumferential displacement between said engagement element and said opening, said resistance torque is greater than any resistance to circumferential displacement between said engagement element and said control shaft.

23. The vehicle wheel axle assembly according to claim 1, including free circumferential displacement between said control shaft and said engagement element.
